(19) United States
(12) Patent Application Publication
(10) Pub. No.: US 2025/0052565 A1
(43) Pub. Date: Feb. 13, 2025

(54) OPTICAL ALIGNMENT TARGETS

(71) Applicant: ILLUMINA, INC., San Diego, CA (US)

(72) Inventors: Shamsul Abedin, San Diego, CA (US); John Earney, San Diego, CA (US); Charles Hubert, San Diego, CA (US); Joseph Pinto, Solana Beach, CA (US); Arthur Pitera, Encinitas, CA (US); Spencer Williams, San Diego, CA (US); Brandon Wenning, San Diego, CA (US); Clayton Braga, San Diego, CA (US)

(21) Appl. No.: 18/799,507

(22) Filed: Aug. 9, 2024

Related U.S. Application Data
(60) Provisional application No. 63/532,272, filed on Aug. 11, 2023.

(51) Int. Cl. G01B 11/27

(52) U.S. Cl. CPC G01B 11/27

(57) ABSTRACT

An example optical alignment target includes a translucent or transparent substrate having a bottom surface; an opaque material formed over the bottom surface in a pattern; an enclosed channel disposed below the bottom surface; and a fluid suspension contained in the enclosed channel. The pattern has an opaque portion of an opaque material and has a gap portion devoid of the opaque material. The fluid suspension includes a carrier liquid and a light emitting material suspended in the carrier liquid. The light emitting material is selected from the group consisting of quantum dots and cerium powder.

### CROSS-REFERENCE TO RELATED APPLICATIONS

This application claims the benefit of U.S. Provisional Application Ser. No. 63/532,272, filed Aug. 11, 2023, the content of which is incorporated by reference herein in its entirety.

### BACKGROUND

Optical targets may be used for calibration, alignment, and/or measurement in optical detection systems. The optical target may be utilized to test the accuracy and performance of the optical system. For example, the optical target affords a basis, with respect to which the optical system may quantify optical resolution, depth of focus, optical and mechanical drift, distortion, lens-based aberration, chromatism, and the like. Thus, optical targets can facilitate accurate calibration of alignment and validation of optical detection systems. Optical targets typically include a light emitting material whose emissions are detected by the optical detection system. The emissions are used for the calibration, alignment, and/or measurement. U.S. Pat. No. 10,261,018 B2, assigned to Illumina, Inc., discloses quantum dots distributed among the bulk of the optical target and fluorescence of the interstitial regions of the optical target.

### SUMMARY

Examples of the optical alignment targets disclosed herein exhibit improved stability, e.g., compared to targets that include an organic dye and a liquid carrier of the organic dye. In one example, the optical alignment target includes a photostable fluorophore as the light emitting material. The photostable fluorophores disclosed herein can be incorporated into a cured matrix, which can help to keep the optical alignment target from drying out. In another example, the optical alignment target includes a patterned resin that does not absorb the excitation light used in the optical alignment process. As such, the patterned resin maintains a lower temperature during the optical alignment process and thus does not undesirably heat an opaque material that is used to define the pattern of the optical alignment target.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a top view of an inspection apparatus including multiple optical alignment targets;

FIG. 2 is a cross-sectional view of a channel of one example of the optical alignment targets disclosed herein;

FIG. 3A and FIG. 3B together depict one example of a method for making one example of the optical alignment targets disclosed herein, where FIG. 3A depicts a UV light curable fluid suspension within a channel exposed to a first light exposure event, and FIG. 3B depicts the UV light curable fluid suspension in the channel exposed to a second light exposure event after voids have been removed;

FIG. 4A and FIG. 4B together depict the same method as shown in FIG. 3A and FIG. 3B, where the optical alignment target includes a different opaque material pattern than that shown in FIG. 3A and FIG. 3B;

FIG. 5A is a cross-sectional view of another example of the optical alignment targets disclosed herein;

FIG. 5B is a cross-sectional view of the optical alignment target of FIG. 5A incorporated into a flow cell configuration;

FIG. 5C is a cross-sectional view of the optical alignment target of FIG. 5A incorporated into a mechanical housing;

FIG. 6A is a cross-sectional view of another example of the optical alignment targets disclosed herein including spacer objects;

FIG. 6B is a cross-sectional view of yet another example of the optical alignment targets disclosed herein including spacer objects;

FIG. 7A through FIG. 7C illustrate an example of a method for making still another example of the optical alignment targets disclosed herein, where FIG. 7A depicts a patterned resin, FIG. 7B depicts an optical target material deposited over the patterned resin, and FIG. 7C depicts the optical target material removed from interstitial regions of the patterned resin;

FIG. 8 is a schematic flow diagram illustrating several example methods for making the optical alignment target shown in E or F;

FIG. 9A is a cross-sectional view of an example of the optical alignment target made by the method of FIG. 7A through FIG. 7C or any of the methods described in reference to FIG. 8, and incorporated into a flow cell configuration;

FIG. 9B is a cross-sectional view the optical alignment target made by the method of FIG. 7A through FIG. 7C or any of the methods described in reference to FIG. 8, and incorporated into a mechanical housing;

FIG. 9C is a cross-sectional view of an example of the optical alignment target made by the method of FIG. 7A through FIG. 7C or any of the methods described in reference to FIG. 8, and incorporated first into a flow cell configuration and then incorporated into a mechanical housing;

FIG. 10 is a top view of a pattern of an optical alignment target used for autofocus;

FIG. 11 is a top view of a pattern of an optical alignment target used for image quality, including a blown-up portion of the pattern;

FIG. 12 is a schematic illustration of a back illumination scheme for an optical alignment target used in an optical alignment method;

FIG. 13 is a schematic illustration of an epifluorescence scheme for an optical alignment target used in an optical alignment method;

FIG. 14 depicts a schematic view of an example of an instrument that may be used with examples of the optical alignment targets disclosed herein;

FIG. 15A is a scanning electron micrograph (SEM) of a portion of a depression and an adjacent interstitial region with a polymeric hydrogel and functionalized nanoparticles applied thereto; and

FIG. 15B is a scanning electron micrograph (SEM) of a portion of the interstitial region of FIG. 15A after the polymeric hydrogel and functionalized nanoparticles are removed therefrom.

### DETAILED DESCRIPTION

Examples of the optical alignment targets disclosed herein may be used for calibration, alignment, and/or measurement in optical instruments. The optical alignment targets incorporate one or more features (e.g., photostable fluorophores or optical targets in a non-fluorescing patterned material) that render the optical alignment target stable.

### Definitions

It is to be understood that terms used herein will take on their ordinary meaning in the relevant art unless specified otherwise. Several terms used herein and their meanings are set forth below.

It is to be understood that terms used herein will take on their ordinary meaning in the relevant art unless specified otherwise. Several terms used herein and their meanings are set forth below.

The singular forms “a”, “an”, and “the” include plural referents unless the context clearly dictates otherwise.

The terms comprising, including, containing and various forms of these terms are synonymous with each other and are meant to be equally broad.

The terms top, bottom, lower, upper, on, etc. are used herein to describe the flow cell and/or the various components of the flow cell. It is to be understood that these directional terms are not meant to imply a specific orientation, but are used to designate relative orientation between components. The use of directional terms should not be interpreted to limit the examples disclosed herein to any specific orientation(s).

The terms first, second, etc. also are not meant to imply a specific orientation or order, but rather are used to distinguish one component from another.

It is to be understood that the ranges provided herein include the stated range and any value or sub-range within the stated range, as if such values or sub-ranges were explicitly recited. For example, a range of about 0.1 μm (100 nm) to about 10 μm (10,000 nm), should be interpreted to include not only the explicitly recited limits of about 0.1 μm to about 10 μm, but also to include individual values, such as about 1 μm, about 5 μm, 7.5 μm etc., and sub-ranges, such as from about 1.25 μm to about 9.25 μm, from about 4 μm to about 8 μm, etc.

Furthermore, when “about” and/or “substantially” are/is utilized to describe a value, they are meant to encompass minor variations (up to +/−10%) from the stated value.

An “analytical apparatus,” as used herein, refers to a device that is incorporated into, or is part of, an optical instrument and that is exposed to excitation light during operation of the optical instrument.

A “curable material” or “curable matrix” refers to an ultraviolet light curable or a thermally curable material that transforms from a liquid state to a solid state upon exposure to, respectively, a predetermined wavelength of ultraviolet light or a predetermined temperature. The curable matrix may also refer to a material that cures when exposed to a predetermined environment (e.g., anaerobic adhesives, aerobic adhesives, etc.). The curable material may or may not undergo cross-linking.

As used herein, the term “flow cell” is intended to mean a vessel having a flow channel where a reaction can be carried out, an inlet for delivering reagent(s) to the flow channel, and an outlet for removing reagent(s) from the flow channel. In some examples, the flow cell accommodates the detection of the reaction that occurs in the flow cell. For example, the flow cell can include one or more transparent surfaces allowing for the optical detection of arrays, optically labeled molecules, or the like.

As used herein, a “flow channel” or “channel” may be an area defined between two bonded components (e.g., substrates), which can selectively receive a gas or a liquid.

An “interposer,” as used herein, refers to a material that bonds two components together. In some examples, the interposer can be a radiation absorbing material that aids in bonding, or can be another material that is put into contact with a radiation absorbing material that aids in bonding.

The term “light emitting material” refers to i) one or more chemical elements, combinations of chemical elements or other materials that are part of a suspension, dispersed in a cured matrix, or immobilized in or on a polymeric hydrogel and that fluoresce, or ii) a material that fluoresces, alone or in cooperation with the host material, when excited.

An “optical alignment target” is a portion of an optical alignment tool that includes a material that is responsive to excitation light, and whose emissions are used for alignment (e.g., optical alignment in all six degrees of freedom, i.e., X, Y, Z, theta-x, theta-y, theta-z) and/or validation (e.g., calibration, quantification, or characterization of optical properties) of imaging modules of an optical instrument. Such imaging modules may be used in, for example, optical detection of samples, such as those samples detected in nucleic acid sequencing procedures. An optical alignment tool may include a single optical alignment target or multiple optical alignment targets.

In some examples, the term “over” may mean that one component or material is positioned directly on another component or material. When one is directly on another, the two are in contact with each other. In other examples, the term “over” may mean that one component or material is positioned indirectly on another component or material. By indirectly on, it is meant that a gap or an additional component or material may be positioned between the two components or materials.

The term “quantum dots” (QD) refers to very small semiconductor particles (e.g., from about 2 nm to about 12 nm in diameter) that have optical and electronic properties that differ from the properties of larger particles. Quantum dots may be designed to emit light of specific frequencies of interest in response to electricity or light applied thereto. The emission frequencies may be tuned by changing the dot size, shape and/or material. In some examples, nanoscale semiconductor materials tightly confine either electrons or electron holes. By way of example, quantum dots may also be referred to as artificial atoms, a term that emphasizes that a quantum dot is a single object with bound, discrete electronic states, as is the case with naturally occurring atoms or molecules. Quantum dots have optoelectronic properties that change as a function of both size and shape. Larger QDs (radius of 5-6 nm, for example) emit longer wavelengths, resulting in emission colors such as orange or red. Smaller QDs (radius of 2-3 nm, for example) emit shorter wavelengths, resulting in emission colors like blue and green. Specific colors and sizes vary depending on the exact composition of the QD.

“Functionalized quantum dots” are quantum dots that have been modified at the surface with functional groups that can covalently attach to a sticky layer. Examples of these functional groups include alkynes or azides.

A “sticky layer” as defined herein is a polymeric hydrogel that is capable of attaching examples of the light emitting material described herein, either through covalent interaction or by at least partially embedding the material.

The term “translucent” refers to a material that is capable of transmitting some wavelengths of light. The term “transparent” refers to a material that is capable of transmitting all or most wavelengths of light. A transparent material transmits more wavelengths of light than a translucent material. Both translucency and transparency may be quantified using transmittance, i.e., the ratio of light energy falling on a body to that transmitted through the body. The transmittance of a transparent or translucent material will depend upon the thickness of the material, the wavelength of light, and the dosage of the light to which it is exposed. In the examples disclosed herein, the transmittance of the transparent or translucent material may range from 0.25 (25%) to 1 (100%). The transparent or translucent material may be a pure material, a material with some impurities, or a mixture of materials, as long as the resulting transparent or translucent material is capable of the desired transmittance. Additionally, depending upon the transmittance of the transparent or translucent material, the time for light exposure and/or the output power of the light source may be increased or decreased to deliver a suitable dose of light energy through the transparent or translucent material to achieve the desired effect (e.g., optical alignment).

### Optical Alignment Tool

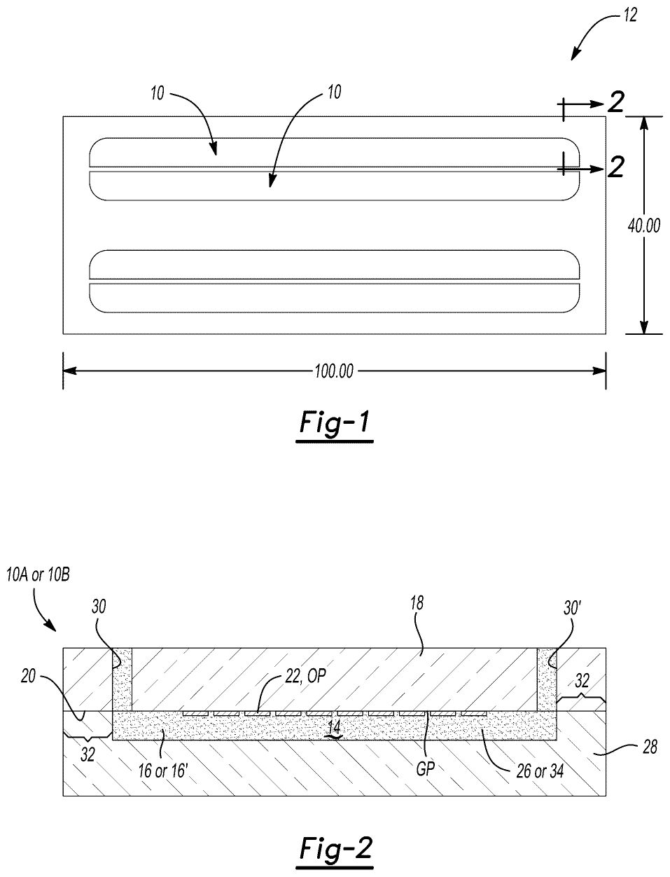

FIG. 1 depicts a top view of one example of an optical alignment tool 12 that includes multiple optical alignment targets 10. In this example, optical alignment tool 12 is designed for an optical instrument (e.g., a sequencer), and the dimensions (e.g., 100.00 mm×40.00 mm) are similar to the analytical apparatus (e.g., a flow cell) that is to be optically addressed using the optical instrument. Thus, this example of optical alignment tool 12 can be readily positioned on the stage of the sequencer for alignment and validation procedures.

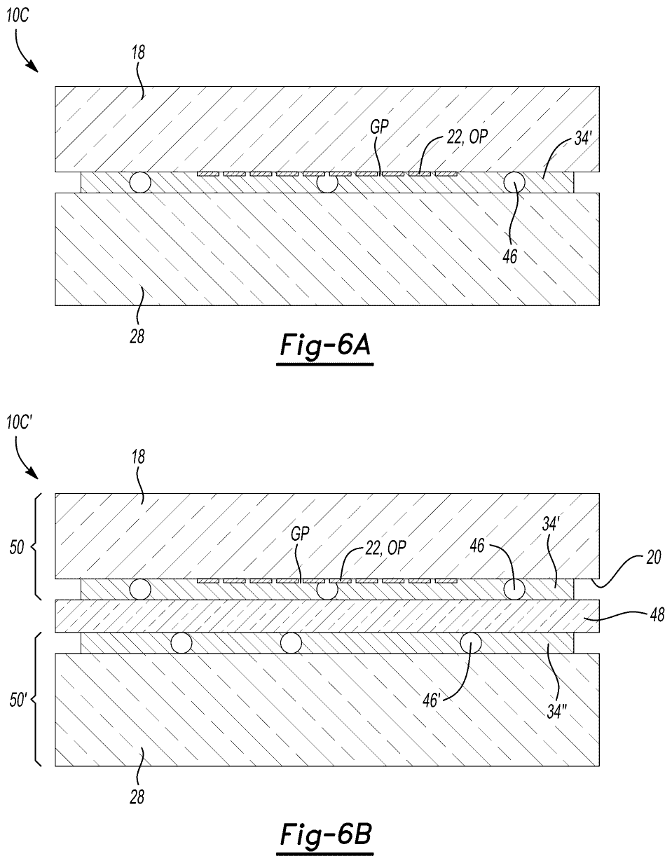

The optical alignment tool 12 includes one or more of the optical alignment targets 10 disclosed herein, which is/are used for optical measurements and analysis of an optical instrument. The optical alignment target(s) 10 shown in FIG. 1 have overall dimensions and relative position that are the same as, or similar to, the optically addressable component(s) of the analytical apparatus. It is to be understood that small differences in size and/or shape can be accommodated, and will not result in a significant reduction in the diagnostic capability of the optical alignment target(s) 10, and the overall optical alignment tool 12. Moreover, non-optical components of the analytical apparatus (i.e., those not addressed by the optical instrument), such as fluid entry and exit ports, may or may not be present in the optical alignment target(s) 10. As one example, the optical alignment target 10 may not have fluid entry and exits ports (see FIG. 6A and FIG. 6B), while the analytical apparatus has entry and exit ports. As another example, a portion of the optical alignment target 10 having fluid entry and exit ports (see FIG. 2) may differ from the portion of the analytical apparatus that has entry and exit ports.

It is to be understood that the optical alignment target(s) 10 may have any shape and/or size i) that resemble the optically addressable component(s) of the analytical apparatus (e.g., a flow cell), and ii) that can be used for alignment (e.g., optical alignment in all six degrees of freedom, i.e., X, Y, Z, theta-x, theta-y, theta-z) and validation (e.g., calibration, quantification, or characterization of optical properties) of imaging modules of the optical instrument.

While not shown, the optical alignment tool 12 can also include identifying indicia such as a serial number, part number, or barcode.

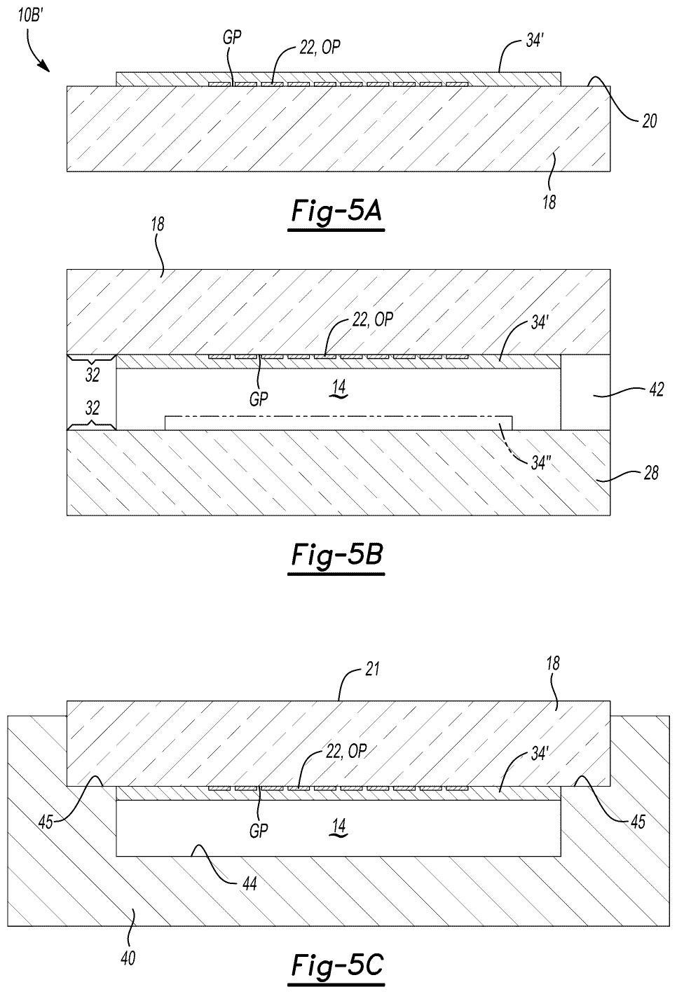

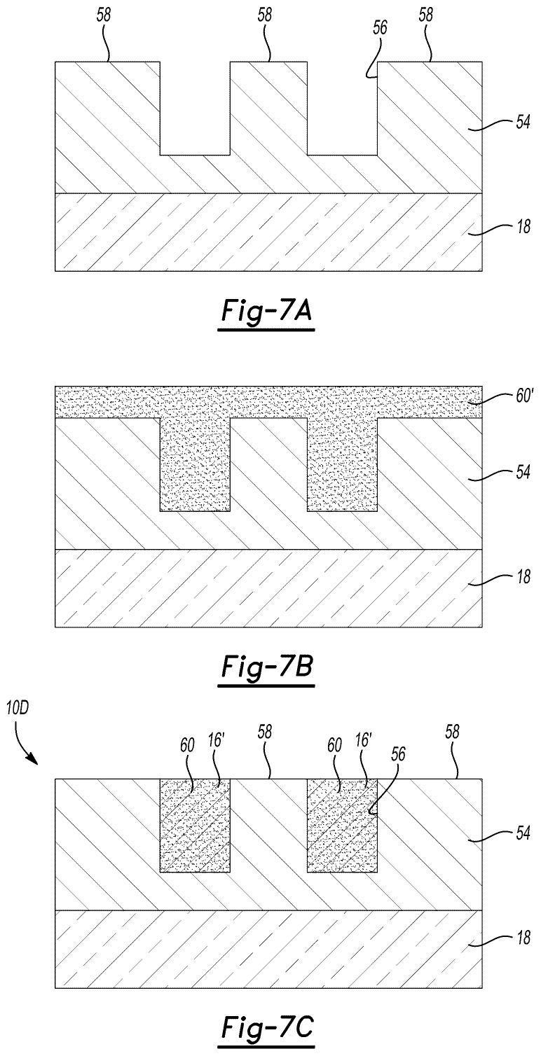

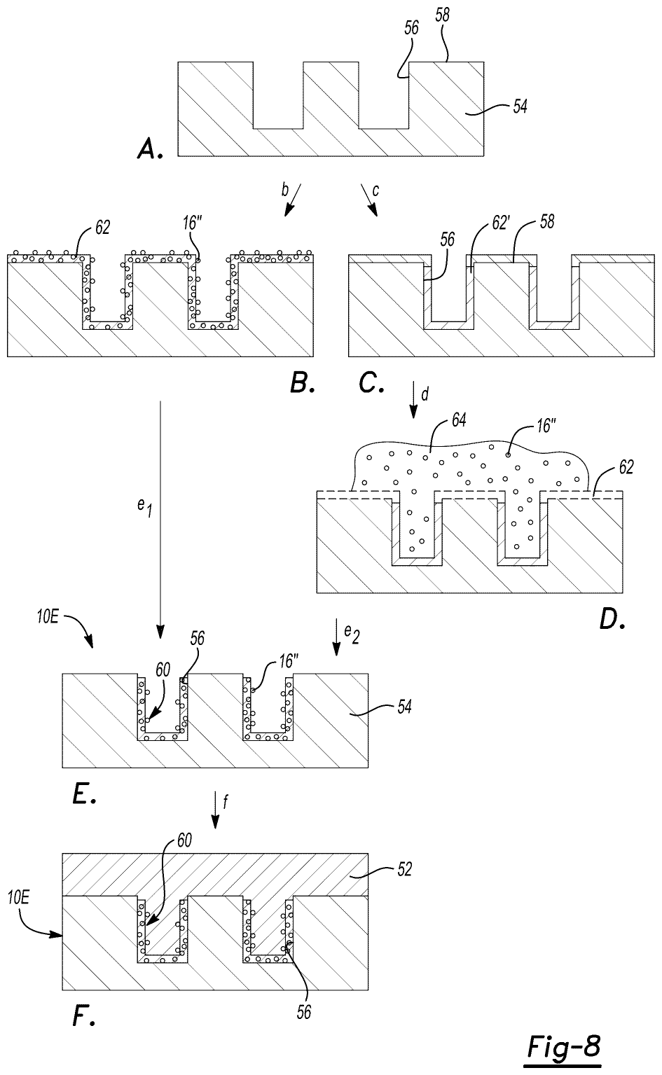

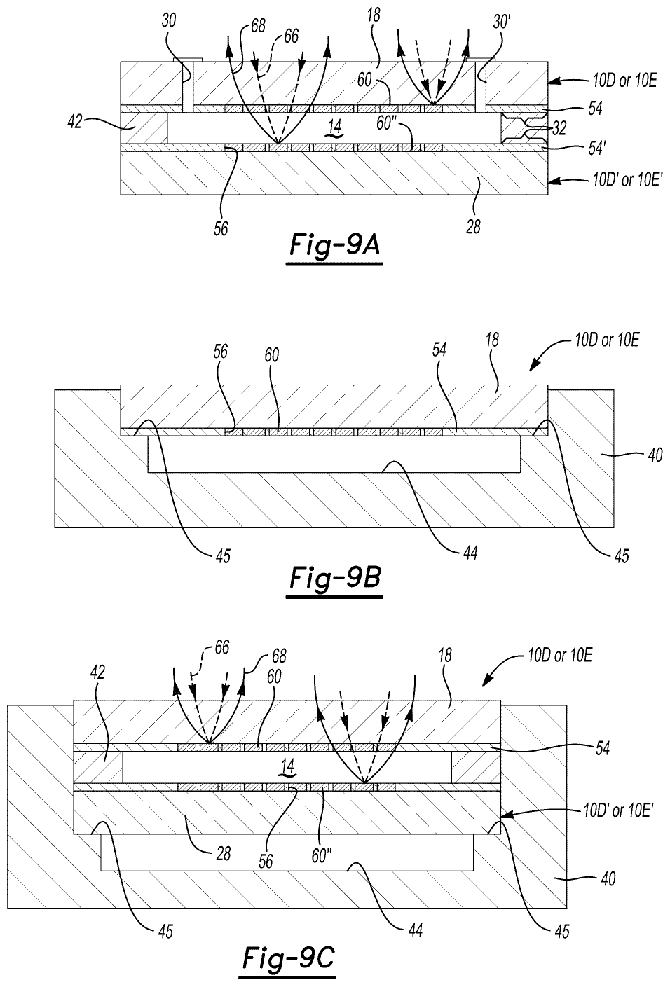

Different examples of the optical alignment target 10 are shown in FIG. 2, FIG. 5A through FIG. 5C, FIG. 6A, FIG. 6B, FIG. 7C, FIG. 8 (at E and F), and FIG. 9A through FIG. 9C. Some of the optical alignment targets 10 include fluidic channels 14 (see, e.g., FIG. 2) that can receive and/or house a fluid suspension, a cured matrix, or gas. Each of the optical alignment targets 10 includes a light emitting material 16, 16′ (see, e.g., FIG. 2) that exhibits fluorescence emission upon exposure to an excitation light. Some of the optical alignment targets 10 include an opaque material 22 formed in a desired pattern (see FIG. 2, FIG. 5A through FIG. 5C, FIG. 6A, and FIG. 6B), and others include depressions 56 formed in a desired pattern (see FIG. 7C, FIG. 8 (at E and F), and FIG. 9A through FIG. 9C). The various configurations of the optical alignment target 10 will be described in reference to the individual figures.

### Optical Alignment Targets Including an Opaque Material

Referring now to FIG. 2, two examples of the optical alignment target 10A, 10B are depicted.

One example of the optical alignment target 10A includes a translucent or transparent substrate 18 having a bottom surface 20; an opaque material 22 formed over the bottom surface 20 in a pattern, the pattern having an opaque portion OP of opaque material 22 and having a gap portion GP devoid of the opaque material 22; an enclosed channel 14 disposed below the bottom surface 20; and a fluid suspension 26 contained in the enclosed channel 14, the fluid suspension 26 including a carrier liquid and a light emitting material 16 suspended in the carrier liquid, the light emitting material 16 being selected from the group consisting of quantum dots and cerium powder.

Another example of the optical alignment target 10B includes the translucent or transparent substrate 18 having the bottom surface 20; the opaque material 22 formed over the bottom surface 20 in a pattern, the pattern having an opaque portion OP of opaque material 22 and having a gap portion GP devoid of the opaque material 22; the enclosed channel 14 disposed below the bottom surface 20; and a cured fluorescent material 34 filling at least the gap portions GP of the pattern.

The optical alignment targets 10A, 10B each include the translucent or transparent substrate 18. This substrate 18 may be any material that is capable of transmitting the light that is used to excite the light emitting material 16, 16′ (e.g., ultraviolet light) and that is emitted from the light emitting material 16, 16′ (e.g., ultraviolet light and/or visible light). In one specific example, the substrate 18 is capable of transmitting blue and green excitation light (e.g., from 450 nm to 570 nm), and blue and green emission light that is slightly red-shifted from the excitation light. As examples, suitable materials include siloxanes, glass, modified or functionalized glass, some polymeric and/or resin materials, inorganic oxides, fused silica, silica-based materials, and silicon nitride (Si₃N₄). Examples of substrate materials that can transmit UV light include inorganic oxides, such as tantalum pentoxide (e.g., Ta₂O₅) or other tantalum oxide(s) (TaOₓ), aluminum oxide (e.g., Al₂O₃), silicon oxide (e.g., SiO₂), hafnium oxide (e.g., HfO₂), indium tin oxide, titanium dioxide, etc., or polymeric resins, such as a polyhedral oligomeric silsesquioxane based resin (e.g., POSS® from Hybrid Plastics), a non-polyhedral oligomeric silsesquioxane epoxy resin, a poly(ethylene glycol) resin, a polyether resin (e.g., ring opened epoxies), an acrylic resin, an acrylate resin, a methacrylate resin, an amorphous fluoropolymer resin (e.g., CYTOP® from Bellex), and combinations thereof. In some examples, the substrate material used has a UV transmittance that ranges from about 0.5 to about 1, e.g., from about 0.75 to about 1, from about 0.9 to about 0.99.

The thickness of the substrate 18 may vary depending upon the type of instrument the optical alignment tool 12 is used with or incorporated into. In an example, thickness of the substrate 18 may range from about 650 μm to about 750 μm. In another example, the thickness of the substrate 18 is about 700 μm+/−10 μm.

As shown in FIG. 2, the substrate 18 may have one or more fluid ports 30, 30′ defined therein that extend from an exterior of the substrate 18 to the channel 14 (i.e., through the bottom surface 20). In one example, a single fluid port 30 is used for fluid ingress and egress. In another example, one fluid port 30 is dedicated for introducing fluid(s) into the channel 14 and a second fluid portion 30′ is dedicated for removing fluid(s) from the channel 14. The target 10A includes the fluid ports 30, 30′ so that the fluid suspension 26 can be introduced. The target 10B may or may not include the fluid ports 30, 30′, depending upon how the cured fluorescent material 34 is to be formed.

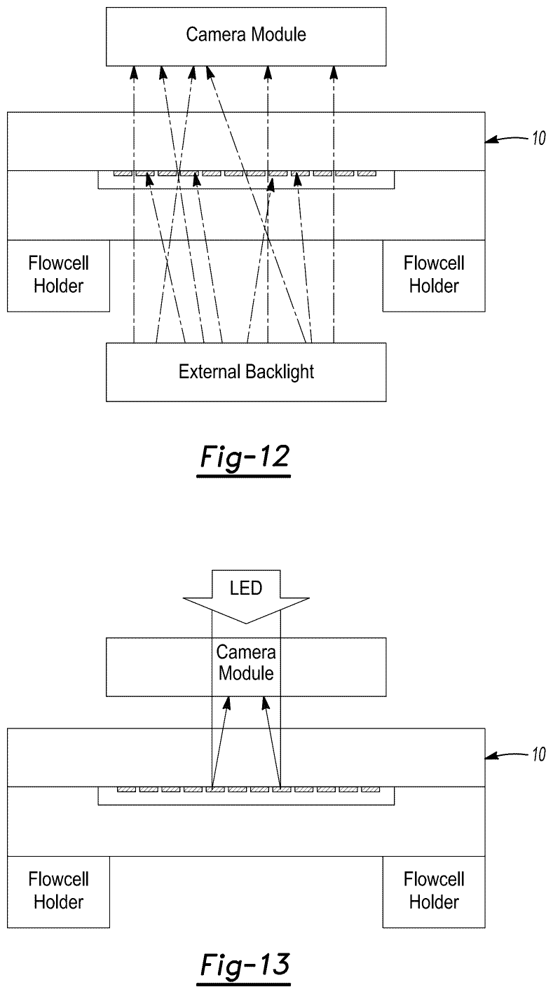

As shown in FIG. 2, this example of the optical alignment target 10A includes the opaque material 22 formed over a portion of the bottom surface 20 in a pattern that includes opaque portion(s) OP and gap portion(s) GP. As will be described in more detail in reference to FIG. 12 and FIG. 13, the opaque portion(s) OP and gap portion(s) GP respectively block and allow transmission of i) the excitation light directed toward the optical alignment target 10 and ii) the emissions from the light emitting material 16, 16′.

The pattern of the opaque material 22 may include stripes, dots, pinholes, cross shapes, or the like. Alternatively, the opaque material 22 may be a substantially continuous coating that includes gap portions GP of a predetermined size formed at a predetermined distance apart from each other.

Examples of suitable opaque materials 22 include chromium (Cr), silver (Ag), and titanium (Ti). In one example, the thickness of the opaque material 22 is about 50 nm.

The opaque material 22 may be formed using any suitable method, including selective application techniques such as printing, masking and depositing, or the like.

The optical alignment targets 10A, 10B include the enclosed channel 14 disposed below the bottom surface 20 of the substrate 18. In the example shown in FIG. 2, the optical alignment targets 10A, 10B further include a second substrate 28 secured to the translucent or transparent substrate 18 such that the enclosed channel 14 is defined between the two substrates 18, 28. Any of the example materials set forth herein for the substrate 18 may be used for the substrate 28. In particular, if it is desirable for the second substrate 28 to have the same optical properties as the substrate 18, the same material may be used for both substrates 18, 28. Alternatively, if it is desirable for the substrate 28 to block transmission of the excitation or emission light, a metal (e.g., aluminum) may be a suitable material for the substrate 28. In still other examples, the substrate 28 is used for mechanical positioning of the portion of the targets 10A, 10B being imaged, and thus any material that has well controlled flatness and thickness may be used. Examples of such materials include glass, ceramic, plastics, or metal. In an example, any of the inorganic oxides set forth herein for the substrate 18 can also be manufactured so that the structure is opaque. In an example, thickness of the substrate 18 may range from about 650 μm to about 850 μm. In another example, the thickness of the substrate 18 is about 800 μm+/−15 μm.

In the example shown in FIG. 2, the substrate 28 has a concave region defined therein that defines the bottom and sides of the enclosed channel 14. The concave region may be formed using any suitable method, such as etching, imprint lithography, stamping, embossing, or another suitable method. The depth of the concave region, and thus the channel 14, can be about 1 μm, about 3 μm, about 10 μm, about 50 μm, about 75 μm, about 100 μm, or more. In an example, the depth may range from about 10 μm to about 100 μm. In another example, the depth may range from about 10 μm to about 30 μm. In still another example, the depth is about 5 μm or less. It is to be understood that the depth of the channel 14 may be greater than, less than or between the values specified above.

The substrates 18 and 28 may be secured together at bonding regions 32 using an adhesive, a thin metal layer, or a polymeric interposer. The bonding regions 32 are designated areas of each of the substrates 18, 28 for direct or indirect attachment to one another. In FIG. 2, the bonding regions 32 form an interface where the surface 20 of the substrate 18 and a surface of the substrate 28 come into direct contact.

The optical alignment target 10A includes the fluid suspension 26 contained in the enclosed channel 14, where the fluid suspension 26 includes a carrier liquid and a light emitting material 16 suspended in the carrier liquid, and where the light emitting material 16 is selected from the group consisting of quantum dots and cerium powder.

The carrier liquid of the fluid suspension 26 is selected from the group consisting of water, ethanol, and ethylene glycol. In an example, the carrier liquid is a high viscosity and/or high boiling point solvent, such as ethylene glycol.

The light emitting material 16 of the fluid suspension 26 is selected from the group consisting of quantum dots and cerium powder. As examples, the quantum dots may be silicon, cadmium selenide, cadmium sulfide, cadmium telluride, graphene, perovskite, indium phosphide, and lead sulfide. When the light emitting material 16 is the cerium powder, the cerium powder includes particles having an average particle size (among the population of particles) of less than 100 nm (e.g., ranging from about 10 nm to less than 100 nm). In one example when the light emitting material 16 is the cerium powder, the cerium powder includes particles having an average particle size (among the population of particles) of from 1 nm to less than 100 nm.

Within the fluid suspension 26, a concentration of the light emitting material 16 in the carrier liquid ranges from about 0.1% to about 5% in terms of number density. In one example, the light emitting material concentration ranges from about 0.1% to about 10.0% in terms of number density.

The quantum dots or cerium powder may be distributed substantially evenly throughout the carrier liquid, such that when the fluid suspension 26 is irradiated by an excitation light, the quantum dots or cerium powder emit(s) fluorescence in one or more predetermined emission bands of interest.

The fluid suspension 26 may also include a stabilization additive dispersed therein. The stabilization additive may improve the colloidal stability of the suspension 26. Suitable stabilization additives include one or more of: an organic acid, an alcohol, an amine, an amide, a sulfate, a sulfonate, a phosphate, and a phosphonate. Specific examples of the stabilization additive are selected from the group consisting of a polymer or copolymer of: poly(ethylene glycol), poly(propylene glycol), polyacrylamide, poly(acrylic acid), poly(methacrylic acid), poly(hydroxy styrene), poly(vinyl alcohol), poly(hydroxythyl acrylate), and poly(hydroxy methyl acrylate). When included in the fluid suspension 26, the amount of the stabilization additive ranges from about 1 wt % to about 5 wt %, based on the total weight of the fluid suspension 26.

The optical alignment target 10B includes the cured fluorescent material 34 filling at least the gap portions GP of the opaque material pattern. In the example shown in FIG. 2, the cured fluorescent material 34 fills the gap portions GP and fills the enclosed channel 14, and the cured fluorescent material 34 is an ultraviolet light cured material or a heat cured material. In another example, the cured fluorescent material 34 fills the gap portions GP, but does not fill the enclosed channel 14. The latter example is shown and further described in reference to FIG. 5A.

When the cured fluorescent material 34 is an ultraviolet light cured material, the ultraviolet light cured material includes: a matrix that is i) transparent to the excitation wavelength and the emission wavelength of a light emitting material 16′ dispersed therein, and ii) selected from the group consisting of a cured liquid photopolymer and a cured epoxy; and the light emitting material 16′ dispersed in the matrix, where the light emitting material 16′ is selected from the group consisting of organic dyes, quantum dots, and cerium powder.

Examples of liquid photopolymers that may be used to form the matrix of the ultraviolet light cured material include NORLAND™ 61 (an optical adhesive), a silicone material, poly(lactide-co-glycolide) (PLGA), poly(N-(5-azidoacetamidylpentyl) acrylamide-co-acrylamide) (PAZAM), or the like. Any ultraviolet light curable epoxy that exhibits the desired light transmission may be used to form the matrix of the cured fluorescent material 34.

When the cured fluorescent material 34 is a heat cured material, the heat cured material includes: a matrix that is transparent to the excitation wavelength and the emission wavelength of a light emitting material 16′ dispersed therein, and the light emitting material 16′ dispersed in the matrix, where the light emitting material 16′ is selected from the group consisting of organic dyes, quantum dots, and cerium powder.

The matrix of the heat cured material is formed of any thermally curable polymer. Examples of thermally curable polymers include silicones, polyurethanes, polyethylene, and polypropylene.

The light emitting material 16′ of the cured fluorescent material 34 is selected from the group consisting of organic dyes, quantum dots, and cerium powder. Examples of suitable organic dyes include a rhodamine dye or an oxazine dye. The quantum dots and cerium powder may be any of the examples set forth herein.

Within the cured fluorescent material 34, the concentration of the light emitting material 16′ will depend upon the amount included in the fluid suspension 26.

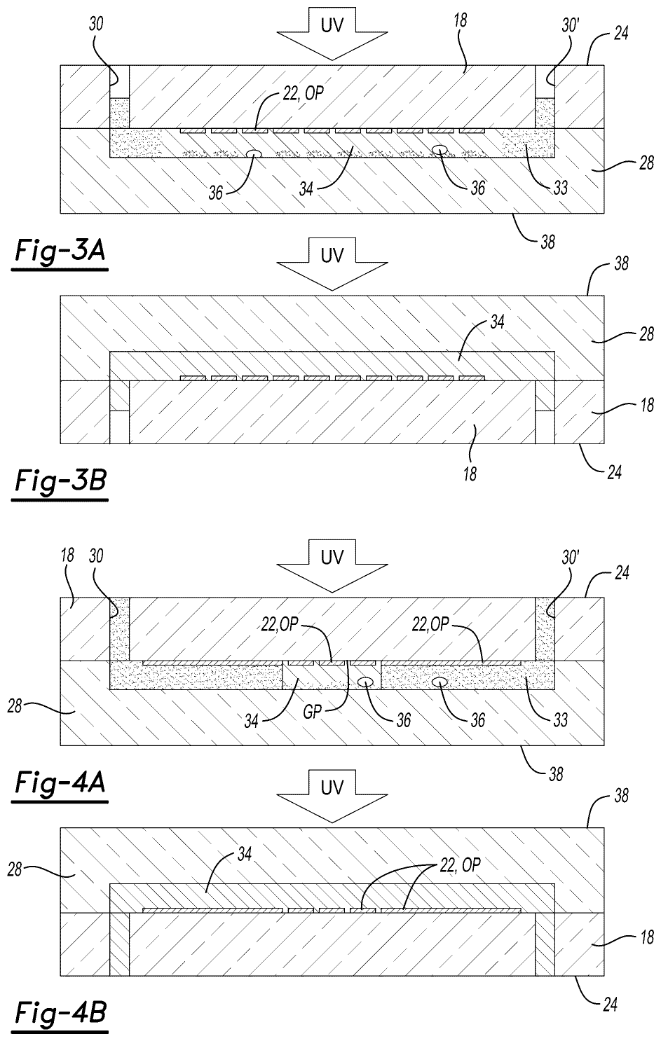

In some instances, the cured fluorescent material 34 also includes a stabilization additive dispersed in the matrix. The stabilization additive is present in the matrix when it is included in the curable fluid suspension (e.g., reference numeral 33 in FIG. 3A and FIG. 3B) used to form the matrix. Examples of stabilization additives include one or more of: an organic acid, an alcohol, an amine, an amide, a sulfate, a sulfonate, a phosphate, and a phosphonate. Specific examples of suitable stabilization additives are selected from the group consisting of a polymer or copolymer of: poly(ethylene glycol), poly(propylene glycol), polyacrylamide, poly(acrylic acid), poly(methacrylic acid), poly(hydroxy styrene), poly(vinyl alcohol), poly(hydroxythyl acrylate), and poly(hydroxy methyl acrylate).

When included in the optical alignment target 10A, 10B, the fluid ports 30, 30′ may be sealed using a sealant, such as silicone, or flexible tape, such as KAPTON™ tape. Seals are desirable for the fluid ports 30, 30′ of the optical alignment target 10A, i.e., when the fluid suspension 26 is used, in order to reduce or prevent dry out. When the cured fluorescent material 34 is formed within the channel 14 (i.e., a curable fluid suspension is introduced into the channel 14 and then cured), a solid is formed in the channel 14 and thus dry out is not an issue. Thus, seals may not be used for the fluid ports 30, 30′ of the optical alignment target 10B, i.e., when the cured fluorescent material 34 is used. As shown in FIG. 2, the cured fluorescent material 34 can fill the port(s) 30, 30′.

A method for making the optical alignment target 10A includes forming the opaque material 22 on the substrate surface 20 in the desired pattern; securing the substrates 18, 28 together at the bonding region(s) 32; introducing the fluid suspension 26 into the channel 14 via the fluid port(s) 30, 30′; and sealing the fluid port(s) 30, 30′.

A method for making the optical alignment target 10B includes forming the opaque material 22 on the substrate surface 20 in the desired pattern; securing the substrates 18, 28 together at the bonding region(s) 32; introducing a curable fluid suspension into the channel 14 via the fluid port(s) 30, 30′; and curing the curable fluid suspension to form the cured fluorescent material 34.

A more specific example of the method for making the optical alignment target 10B including the ultraviolet light cured material (as the cured fluorescent material 34) is shown in FIG. 3A and FIG. 3B and in FIG. 4A and FIG. 4B. This example method includes introducing an ultraviolet (UV) light curable fluid suspension 33 into the channel 14 of the optical alignment target 10B (which includes two translucent or transparent substrates 18, 28 as defined herein); directing ultraviolet light through the first translucent or transparent substrate 18 toward the channel 14 (see FIG. 3A and FIG. 4A), thereby solidifying portions of the UV light curable fluid suspension 33 exposed to the UV light (forming some of the cured fluorescent material 34), whereby unexposed portions of the UV light curable fluid suspension 33 remain in suspension form, and whereby voids 36 form in the remaining UV light curable fluid suspension 33 (see FIG. 3A and FIG. 4A); and directing ultraviolet light through the second translucent or transparent substrate 28 toward the channel 14, thereby solidifying the remaining UV light curable fluid suspension 33 exposed to the UV light, and whereby at least some of the voids 36 are filled (see FIG. 3B and FIG. 4B).

The difference between the optical alignment target 10B in FIG. 3A and FIG. 3B and in FIG. 4A and FIG. 4B is the pattern of the opaque material 22. This difference illustrates where void 36 formation may take place.

In the method shown in FIG. 3A and FIG. 3B and FIG. 4A and FIG. 4B, the UV light curable fluid suspension 33 is first introduced into the channel 14 through one or more of the port(s) 30, 30′.

In one example, the UV light curable fluid suspension 33 includes: the UV curable material that is i) transparent to an excitation wavelength and an emission wavelength of the light emitting material 16′ and ii) selected from the group consisting of a liquid photopolymer and an epoxy; and the light emitting material 16′ selected from the group consisting of organic dyes, quantum dots, and cerium powder. Any of the UV curable materials (e.g., liquid photopolymers or UV curable epoxies) and any of the light emitting materials 16′ disclosed herein may be used in this example.

In another example, the UV light curable fluid suspension 33 includes: quantum dots; a stabilization additive; the UV curable material; and a solvent blend including a first solvent that is compatible with the UV curable material and a second solvent that dissolves the quantum dots. Any of the UV curable materials (e.g., liquid photopolymers or UV curable epoxies), any of the stabilization additives, and any of the light emitting materials 16′ disclosed herein may be used in this example.

The amount of the stabilization additive included in this example of the UV light curable fluid suspension 33 ranges from about 1 wt % to about 5 wt % of a total weight of the UV light curable fluid suspension 33. The stabilization additive is specifically selected to reduce the interfacial tension between the quantum dots and the solvent blend. The stabilization additive prevents the aggregation and clumping of the quantum dots by forming a chelator-like coating at the surface of the quantum dots in the solvent blend.

Additionally, the solvent blend included in this example of the UV light curable fluid suspension 33 includes one solvent that is compatible with the UV curable material (i.e., the solvent solubilizes the UV curable material) and a second solvent that dissolves the quantum dots. The solvent blend helps to ensure that the quantum dots and the UV curable material are uniformly distributed throughout the UV light curable fluid suspension 33 that is introduced into the channel 14. In one example, the first solvent is propylene glycol monomethyl ether acetate (PGMEA); the second solvent is toluene; and a weight ratio of the first solvent to the second solvent ranges from 40:60 to 75:25. In another example, the weight ratio of the first solvent to second solvent ranges from 40:60 to 60:40.

The UV light curable fluid suspension 33 may be introduced through one or more of the port(s) 30, 30′ using any suitable fluid delivery technique.

Once the UV light curable fluid suspension 33 is in the channel 14, UV light is directed toward the channel 14 through the outer surface 24 of the substrate 18. This is a first UV light exposure event. During this event, the UV light is blocked by the opaque material 22 (portions OP), but is transmitted through the gap portions GP. The volume of the UV light curable fluid suspension 33 right below the gap portions GP cures into the cured fluorescent material 34. In some instances, the entire thickness of the UV light curable fluid suspension 33 below the gap portions GP will cure.

The UV curable material of the UV light curable fluid suspension 33 will shrink during curing, which can cause voids 36 to form in the cured fluorescent material 34. By shining the UV light through the outer surface 24 of the substrate 18 and toward the opaque material 22, solidification takes place at the gap portions GP and forces voids 36 to be in areas behind the opaque portions OP. If these voids remain after the second UV light exposure event described herein, they will not be visible by the detection system since they are positioned under the opaque material 22.

For the second UV light exposure event, ultraviolet light is directed through the second translucent or transparent substrate 28 starting at the surface 38 and toward the channel 14. As shown in FIG. 3B and FIG. 4B, the UV light is exposed to the UV light curable fluid suspension 33 in the entire channel 14 and in the port(s) 30, 30′. In the second UV light exposure event, the light does not pass through the pattern of the opaque material 22 in order to reach the UV light curable fluid suspension 33. The second UV light exposure event solidifies the remaining UV light curable fluid suspension 33. In the examples shown in FIG. 3B and FIG. 4B, the optical alignment target 10B is flipped between the first and second UV light exposure events. Alternatively, the UV light source can be moved into a suitable position for each of the two UV light exposure events (i.e., through surface 24 and then through surface 38).

During the first UV light exposure event, the UV light exposure is controlled so that the port(s) 30, 30′ are not exposed to the UV light. This allows the UV light curable fluid suspension 33 to remain in suspension form within the port(s) 30, 30′. Because the suspension 33 remains within the port(s) 30, 30′ at the outset of the second UV light exposure event, some of the remaining UV light curable fluid suspension 33 can get pulled into the channel 14 as the suspension 33 cures and shrinks during the second UV light exposure event. This can fill at least some of the previously formed voids 36.

As a result of the second UV light exposure event, the suspension 33 remaining in the port(s) 30, 30′ (if any) is cured.

Referring now to FIG. 5A through FIG. 5C, another example of the optical alignment target 10B′ is depicted. In this example, the cured fluorescent material 34′ is a very thin film that fills the gap portions GP and that may overlie the opaque material 22 depending upon the thickness of the thin film and the thickness of the opaque material 22. In this example, the cured fluorescent material 34′ has a thickness ranging from about 0.1 μm to about 10 μm.

The cured fluorescent material 34′ may be any of the examples of the cured fluorescent material 34 set forth herein in reference to FIG. 2. In one specific example, the cured fluorescent material 34′ fills the gap portions GP, and is an ultraviolet light cured thin film having a thickness ranging from about 0.1 μm to about 10 μm. In another specific example, the cured fluorescent material 34′ fills the gap portions GP, and is a heat cured thin film having a thickness ranging from about 0.1 μm to about 10 μm.

To form the optical alignment target 10B′ shown in FIG. 5A, one example of the method may involve providing a translucent or transparent substrate 18 having the opaque material 22 applied to the surface 20 in a pattern that includes at least some exposed portions of the translucent or transparent substrate 18 (i.e., at least some gap portions GP); applying an ultraviolet (UV) light curable fluid suspension (e.g., suspension 33) over the opaque material 22 and over the exposed/gap portions GP to form a thin film having a thickness ranging from about 0.1 μm to about 10 μm; and exposing the thin film to UV light to form a cured thin film, which is one example of the cured fluorescent material 34′. In one example, the UV light curable fluid suspension, e.g., suspension 33, includes any example of the light emitting material 16′ suspended in any example of the UV curable material described herein. This example of the UV light curable fluid suspension may be deposited onto the surface 20 (or a portion of the surface) by spin coating, spraying, or using another thin film deposition technique, and then exposed to UV light to cure the thin film into a cured (solid) thin film. In another example, the UV light curable fluid suspension include quantum dots, the stabilization additive, the UV curable material, and the solvent blend. This example of the UV light curable fluid suspension may be deposited onto the surface 20 (or a portion of the surface) by spin coating, spraying, or using another thin film deposition technique, exposed to a baking step to initiate solvent blend evaporation, and then exposed to UV light to cure the thin film into a cured (solid) thin film.

Another example of the method may involve providing a translucent or transparent substrate 18 having the opaque material 22 applied to the surface 20 in a pattern that includes at least some exposed portions of the translucent or transparent substrate 18 (i.e., at least some gap portions GP); applying a thermally curable fluid suspension over the opaque material 22 and over the exposed/gap portions GP to form a thin film having a thickness ranging from about 0.1 μm to about 10 μm; and exposing the thin film to heat to form a cured thin film (i.e., cured fluorescent material 34′). In one example, the heat curable fluid suspension includes any example of the light emitting material 16′ suspended in any example of the heat curable material described herein. This example of the heat curable fluid suspension may be deposited onto the surface 20 (or a portion of the surface) by spin coating, spraying, or using another thin film deposition technique, and then exposed to heat to cure the thin film into a cured (solid) thin film. In another example, the heat curable fluid suspension includes quantum dots, the stabilization additive, a heat curable material, and the solvent blend. Any of the quantum dots, heat curable materials, stabilization additives, and solvent blends may be used in this example. This example of the heat light curable fluid suspension may be deposited onto the surface 20 (or a portion of the surface) by spin coating, spraying, or using another thin film deposition technique, exposed to a baking step to initiate solvent blend evaporation, and then exposed to heat sufficient to cure the thin film into a cured (solid) thin film. In this example, the baking and curing may be accomplished sequentially or simultaneously depending upon the solvents used and heat curable material that are used.

During the deposition of the suspension 33, portion(s) of the surface 20 that are to be bonded to the substrate 28 may be masked so that it/they are free of the film 34′ and are available for bonding.

The optical alignment target 10B′ may be used as shown in FIG. 5A. In this example, the optical alignment target 10B′ may be positioned in a receptacle of an optical instrument and used for alignment and/or validation as described herein in reference to FIG. 12 or FIG. 13. The thickness of the cured fluorescent material 34′ may be particularly desirable when the corresponding analytical apparatus is a flow cell. The thin film form of the cured fluorescent material 34′ may enable a more accurate measurement of an illumination light profile of the flow cell compared to the example cured fluorescent material 34 shown in FIG. 2 because the thin film results in a thin sheet of fluorescence, which is similar to sequencing clusters in the flow cell. Because the cured fluorescent material 34′ formed from the suspension 33 containing the stabilization additive may have less clumping or agglomeration of the quantum dots, the illumination light profile of this example may be even further improved.

The optical alignment target 10B′ may be incorporated into a device that resembles the corresponding analytical apparatus (FIG. 5B), or into a mechanical housing 40 that is part of an optical instrument or can be introduced into an optical instrument (FIG. 5C).

In the example shown in FIG. 5B, the substrate 18 of the optical alignment target 10B′ is attached to a second translucent or transparent substrate 28 to form the channel 14 therebetween, and the cured thin film 34′ is positioned in the channel 14. Any of the example materials set forth herein for the substrate 18 may be used for the substrate 28. In one example, both substrates 18, 28 are glass. In another example, the substrate 18 is glass and the substrate 28 is glass, metal, ceramic, or plastic.

In the example shown in FIG. 5B, the second translucent or transparent substrate 28 has a substantially flat surface, and an interposer 42 is used to attach the substrates 18, 28 together. The interposer 42 is attached to each of the first translucent or transparent substrate and the second translucent or transparent substrate at respective bonding regions 32. In this example, the interposer 42 defines the walls of the channel 14.

The interposer 42 may be any material that will seal portions of the substrates 18, 28. As an example, the interposer 42 may be a radiation-absorbing material that aids in bonding. An example of the radiation-absorbing material is KAPTON® black (a polyimide film from DuPont). Another example of a suitable material for the interposer 42 is black polyethylene terephthalate (PET). This interposer 42 may be adhered to both substrates 18, 28 using an adhesive, such as a methyl acrylic adhesive.

The method used to form the optical alignment target 10B′ would further include attaching the translucent or transparent substrate 18 to a second translucent or transparent substrate 28 to form the channel 14 therebetween. In one example, the interposer 42 is positioned between the substrates 18, 28 at the bonding regions 32, and exposed to laser bonding, which melts the interposer 42 to the substrates 18, 28 in a bond line. In another example, the interposer 42 is adhered to the bonding regions with an additional adhesive. In still another example, fusion bonding is used to attach the substrates 18, 28.

While not shown in FIG. 5B, it is to be understood that the second translucent or transparent substrate 28 may have the concave region defined therein, and an adhesive may be used to attach the optical alignment target 10B′ to the second translucent or transparent substrate 28. This example is similar to the examples described in reference to FIG. 2, and would not include the interposer 42.

The example shown in FIG. 5B may include another thin film, shown as cured fluorescent material 34″, over at least a portion of the second translucent or transparent substrate 28. In this particular example, the optical alignment target 10B′ further includes the second translucent or transparent substrate 28 attached to the first translucent or transparent substrate 18 such that the enclosed channel 14 is formed therebetween, and a second ultraviolet light or heat cured thin film, e.g., 34″, positioned over the second translucent or transparent substrate 28 and in the channel 14. This cured fluorescent material 34″ (i.e., the second ultraviolet light or heat cured thin film) also has a thickness ranging from about 0.1 μm to about 10 μm, and can be formed in the same manner as the cured fluorescent material 34′. The inclusion of the additional cured fluorescent material 34″ may be desirable when the corresponding analytical apparatus is a flow cell with sequencing clusters on both substrates. This is because the dual surface configuration of the films 34′, 34″ mimics the inner surfaces of the flow cell substrates where analytes with fluorescent labels are sequenced. Thus, the films 34, 34′ can provide image quality, focus, and other alignment and validation information that is relevant for the type of analytical device being used.

To form the example with the additional cured fluorescent material 34″, prior to attaching the translucent or transparent substrate 18 to the second translucent or transparent substrate 28, the method would further include applying the curable fluid suspension over the second translucent or transparent substrate 28 to form a second thin film having a second thickness ranging from about 0.1 μm to about 10 μm; and exposing the second thin film to UV light or heat to form a second cured fluorescent material 34″. The substrates 18, 28 are then attached to each other so that the cured fluorescent materials/thin films 34′, 34″ are each positioned within the channel 14. As described herein, this attachment may involve securing the interposer 42 at the bonding regions 32 of each of the substrates 18, 28.

In another example, as shown in FIG. 5C, the optical alignment target 10B′ is incorporated into a mechanical housing 40. This mechanical housing 40 may be mounted within an optical instrument, or may be loaded in and unloaded from an optical instrument. In one example, the mechanical housing 40 containing the optical alignment target 10B′ is mounted on the flow cell stage of a sequencer. In another example, the mechanical housing 40 containing the optical alignment target 10B′ is loaded onto a flow cell holder of a sequencer in the same manner as the flow cell cartridge.

The mechanical housing 40 includes an inset region 45 (i.e., a receptacle) that that leads to a pocket 44. The inset region 45 functions as a receptacle for the optical alignment target 10B′. In one example, the optical alignment target 10B′ can be positioned within the inset region 45 so that the perimeter of the optical alignment target 10B′ contacts the surfaces of the inset region 45. In this position, the opaque material 22 and the cured fluorescent material 34′ face the pocket 44 of the mechanical housing 40. The optical alignment target 10B′ may be secured within the inset region 45 in various manners, such as with an adhesive. The inset region 45 may also be formed with peripheral features that securely engage with peripheral walls of the optical alignment target 10B′ (e.g., in a press fit manner). When secured to the mechanical housing 40, the opaque material 22 and the cured fluorescent material 34′ may be hermetically sealed from the external environment.

The mechanical housing 40 may be formed of aluminum or another material having no more than about 20% reflectivity. Low reflectivity is particularly desirable for proper measurement of the illumination footprint at an image plane 21 of the optical alignment tool 12. If the housing 40 reflectivity is too high, light will reflect off of a surface of the pocket 44 and add to the illumination from the cured fluorescent material 34′.

The mechanical housing 40 may be formed through a milling process or another manufacturing process that affords desired tolerances for the various ledges, walls, etc. discussed herein.

Referring now to FIG. 6A and FIG. 6B, these figures depict additional examples of the optical alignment targets 10C, 10C′. In these examples, spacer objects 46, 46′ of a predetermined size are incorporated into the cured fluorescent material(s) 34′ or 34′ and 34″. The predetermined size is a diameter ranging from about 0.1 μm to about 10 μm. The spacer objects 46, 46′ help to define the distance between the substrates 18 and 28 (FIG. 6A), or the distance between the respective substrates 18 or 28 and a glass spacer 48. Examples of suitable spacer objects 46, 46′ are selected from the group consisting of glass particles, polystyrene particles, and silicon dioxide particles.

In FIG. 6A, the optical alignment target 10C includes the first translucent or transparent substrate 18 having the bottom surface 20 and the opaque material 22 applied on the bottom surface 20 in a pattern that contains gap portions GP; the second translucent or transparent substrate 28; the cured thin film 34′ (including the light emitting material 16′ suspended therein) positioned between the first and second translucent or transparent substrates 18, 28; and spacer objects 46 of the predetermined size positioned within the cured thin film 34′. In this example, the spacer objects 46 define at least a portion of a distance between the first translucent or transparent substrate 18 and the second translucent or transparent substrate 28.

In the optical alignment target 10C, the first translucent or transparent substrate 18, the opaque material 22, the second translucent or transparent substrate 28, and the cured thin film 34′ may be any of the examples disclosed herein.

The optical alignment target 10C may be formed by the following method. The ultraviolet (UV) light curable fluid suspension described in reference to FIG. 3A through FIG. 4B may be used (reference numeral 33, not shown in FIG. 6A). This ultraviolet (UV) light curable fluid suspension includes any example of the UV light curable material, any example of the light emitting material 16′, and a low concentration of the spacer objects 46. By “low concentration,” it is meant that there is from about 1 spacer object 46 per mm² of bonding area (i.e., area where the substrates 18, 28 contact the cured thin film 34′ or glass spacer 48) to about 1,000 spacer objects 46 per mm² of bonding area. In one example, there are about 100 spacer objects 46 per mm² of bonding area. Other examples of the ultraviolet (UV) light curable fluid suspension include the quantum dots, the stabilization additive, the UV light curable material, the solvent blend, and the low concentration of the spacer objects 46.

The suspension is applied to the surface 20 of the substrate 18 using any of the techniques described herein for the suspension 33. Specific examples of suitable techniques include those described in reference to FIG. 5A. The thickness of the applied film may range from about 0.1 μm to about 10 μm. Alternatively, a thicker film may be applied as the spacer objects 46 are used in this example to define thickness of the cured fluorescent material 34′ that is formed.

Once the suspension is applied, the second translucent or transparent substrate 28 is then put into contact with the applied suspension. Pressure is applied to the substrate 28 until the spacer objects 46 prevent further movement of the substrate 28 toward the substrate 18. Thus, the predetermined size of the spacer objects 46 will dictate the thickness of the cured fluorescent material 34′ that is formed. Additionally, if the spacer objects 46 are slightly compliant, this will enable the thin film thickness to shrink during curing rather than voids 36 forming (if the UV light curable material shrinks as it cures). As such, the resulting cured thin film 34 has a thickness equal to or less than the predetermined size of the spacer objects 46.

When the solvent blend is present in the suspension, the structure may be exposed to the baking step described herein in order to initiate evaporation of the solvents.

UV light is then directed through the substrate 28 to form the cured fluorescent material 34′ having the spacer objects 46 therein. The UV light is directed through the substrate 28 so that the opaque material 22 does not partially block the light. The cured fluorescent material 34′ attaches the two substrates 18, 28 together.

The dimensions of the optical alignment target 10C may correspond with any analytical apparatus, such as a flow cell. In one example, several isolated cured fluorescent materials 34′ are formed between the substrates 18, 28 in the shape of flow cell lanes or channels.

In FIG. 6B, the optical alignment target 10C′ includes first and second structures 50, 50′ separated by the glass spacer 48. The first structure 50 includes the translucent or transparent substrate 18, the opaque material 22 formed over the bottom surface 20 in a pattern that contains gap portions GP, the cured fluorescent material 34′, and the spacer objects 46 in the cured fluorescent material 34′. The second structure 50′ includes the translucent or transparent substrate 28, the cured fluorescent material 34″, and the spacer objects 46′ in the cured fluorescent material 34″. The glass spacer 48 is positioned between the cured fluorescent materials 34′ and 34″.

The optical alignment target 10C′ may be formed by the following method. The ultraviolet (UV) light curable fluid suspension described in reference to FIG. 3A through FIG. 4B may be used (reference numeral 33, not shown in FIG. 6B). In one example, this ultraviolet (UV) light curable fluid suspension includes any example of the UV light curable material, any example of the light emitting material 16′, and a low concentration of the spacer objects 46 or 46′. In another example, this ultraviolet (UV) light curable fluid suspension includes the quantum dots, the stabilization additive, the UV light curable material, the solvent blend, and the low concentration of the spacer objects 46 or 46′.

The suspension containing the spacer objects 46 is applied to the surface 20 of the substrate 18 using any of the techniques described herein for the suspension 33. The thickness of the applied film may range from about 0.1 μm to about 10 μm; or a thicker film may be applied as the spacer objects 46 are used in this example to define thickness of the cured fluorescent material 34′ that is formed.

Once the suspension is applied, the glass spacer 48 is then put into contact with the applied suspension. Pressure is applied to the glass spacer 48 until the spacer objects 46 prevent further movement of the glass spacer 48 toward the substrate 18. Thus, the predetermined size of the spacer objects 46 will dictate the thickness of the cured fluorescent material 34′ that is formed. In particular, the resulting cured thin film 34′ has a thickness equal to or less than the predetermined size of the spacer objects 46.

When the solvent blend is present in the suspension, the structure may be exposed to the baking step described herein in order to initiate evaporation of the solvents.

UV light is then directed through the glass spacer 48 to form the cured fluorescent material 34′ having the spacer objects 46 therein. The UV light is directed through the glass spacer 48 so that the opaque material 22 does not partially block the light. The cured fluorescent material 34′ attaches the substrate 18 and the glass spacer 48 together.

The suspension containing the spacer objects 46′ is the applied to the exposed surface of the glass spacer 48 or to one of the surfaces of the substrate 28 using any of the techniques described herein for the suspension 33. The thickness of the applied film may range from about 0.1 μm to about 10 μm; or a thicker film may be applied as the spacer objects 46′ are used in this example to define thickness of the cured fluorescent material 34″ that is formed.

When the suspension is the applied to the exposed surface of the glass spacer 48, the substrate 28 is then put into contact with the applied suspension. When the suspension is the applied to the substrate 28, the exposed surface of the glass spacer 48 is then put into contact with the applied suspension. In either example, pressure is applied in a manner that pushes the substrates 18, 28 toward one another until the spacer objects 46′ prevent further movement. Thus, the predetermined size of the spacer objects 46′ will dictate the thickness of the cured fluorescent material 34″ that is formed. In particular, the resulting cured thin film 34″ has a thickness equal to or less than the predetermined size of the spacer objects 46′.

When the solvent blend is present in the suspension, the structure may be exposed to the baking step described herein in order to initiate evaporation of the solvents.

UV light is then directed through the substrate 28 to form the cured fluorescent material 34″ having the spacer objects 46′ therein. The UV light is directed through the substrate 28 so that the opaque material 22 does not partially block the light. The cured fluorescent material 34″ attaches the substrate 28 and the glass spacer 48 together.

In one example of the optical alignment target 10C′, each of the cured fluorescent material 34′ and the second cured fluorescent material 34″ is a respective ultraviolet light cured thin film having a thickness ranging from about 0.1 μm to about 10 μm, and each of the respective ultraviolet light cured thin films includes the matrix that is transparent to an excitation wavelength and an emission wavelength of a light emitting material dispersed therein, and the light emitting material 16′ selected from the group consisting of organic dyes, quantum dots, and cerium powder.

The dimensions of the optical alignment target 10C′ may correspond with any analytical apparatus, such as a flow cell. As noted herein, the inclusion of the additional cured fluorescent material 34″ may be desirable when the corresponding flow cell is capable of generating sequencing clusters on both substrates. In one example, several isolated cured fluorescent materials 34′ and 34″ are formed between the respective substrates 18, 28 and the glass spacer 48 in the shape of flow cell lanes or channels.

While the description of the optical alignment targets 10C, 10C′ relates to the (UV) light curable fluid suspension, it is to be understood that the methods may be performed with any example of the heat curable material, and heat exposure is used in place of UV light exposure to cure the material. Thus, the optical alignment targets 10C, 10C′ may include a heat cured material that contains the spacer objects 46, 46′.

While not shown, it is to be understood that either of the optical alignment targets 10C, 10C′ may be incorporated into a mechanical housing 40 that is part of an optical instrument or that can be introduced into an optical instrument (in a manner similar to the example shown in FIG. 9C).

### Optical Alignment Targets Including Depressions

Still other examples of the optical alignment targets 10D, 10E are shown and described in reference to FIG. 7A through FIG. 9C. Generally, these optical alignment targets 10D, 10E include a substrate 18; a patterned and translucent or transparent material 54 over the substrate 18, the patterned translucent or transparent material 54 including depressions 56 separated by interstitial regions 58; and an optical target 60 in each of the depressions 56, the optical target 60 including: i) a cured translucent or transparent matrix having a first light emitting material 16′ suspended therein; or ii) a sticky layer having a second light emitting material 16″ attached thereto or at least partially embedded therein.

In these examples of the optical alignment targets 10D, 10E, the light emitting material 16, 16″ is present within the microstructures (e.g., depressions 56) that are defined within the patterned material 54, rather than distributed throughout a bulk material present in a channel 14 of the optical alignment target. Since the light emitting material 16′, 16″ is confined formed with the depression 56 defined by the patterned material 54, fluorescence occurs from the depressions 56 and not from the interstitial regions 58. These examples are similar to patterned flow cells having depressions that contain the surface chemistry for designated reactions and to flow cells with designated areas for receiving samples, e.g., samples having fluorescent labels. As such, the optical targets 10D, 10E may increase the precision and accuracy of alignment/correction/etc. for optical detection systems that use these types of flow cells.

Any example of the substrate 18 described herein may be used in the optical alignment targets 10D, 10E.

The patterned translucent or transparent material 54 may be any material that i) is capable of transmitting the light that is used to excite the light emitting material 16′ (e.g., ultraviolet light) and that is emitted from the light emitting material 16′ (e.g., ultraviolet light and/or visible light), and ii) can be patterned with depressions 56. Examples of suitable translucent or transparent materials 54 include inorganic oxides, such as tantalum pentoxide (e.g., Ta₂O₅) or other tantalum oxide(s) (TaOₓ), aluminum oxide (e.g., Al₂O₃), silicon oxide (e.g., SiO₂), hafnium oxide (e.g., HfO₂), indium tin oxide, titanium dioxide, etc., or polymeric resins, such as a polyhedral oligomeric silsesquioxane based resin (e.g., POSS® from Hybrid Plastics), a non-polyhedral oligomeric silsesquioxane epoxy resin, a poly(ethylene glycol) resin, a polyether resin (e.g., ring opened epoxies), an acrylic resin, an acrylate resin, a methacrylate resin, an amorphous fluoropolymer resin (e.g., CYTOP® from Bellex), and combinations thereof.

The patterned translucent or transparent material 54 has depressions 56 defined therein, where each depression 56 is separated from each other depression 56 by interstitial regions 58. The depressions 56 house the optical target 60, and thus are similar to the gap regions GP in the examples disclosed herein in reference to FIG. 2 through FIG. 6B. The interstitial regions 58 are more akin to the opaque portions OP in the examples disclosed herein in reference to FIG. 2 through FIG. 6B.

Many different layouts of the depressions 56 are envisaged, including regular, repeating, and non-regular patterns. In an example, the depressions 56 are disposed in a hexagonal grid for close packing and improved density. Other layouts may include, for example, rectangular layouts, triangular layouts, and so forth. In one example, the layout or pattern of depressions 56 can be an x-y format in rows and columns.

The layout or pattern may be characterized with respect to the density (number) of the depressions 56 in a defined area. For example, the depressions 56 may be present at a density of approximately 2 million per mm². The density may be tuned to different densities including, for example, a density of about 100 per mm², about 1,000 per mm², about 0.1 million per mm², about 1 million per mm², about 2 million per mm², about 5 million per mm², about 10 million per mm², about 50 million per mm², or more, or less. It is to be further understood that the density can be between one of the lower values and one of the upper values selected from the ranges above, or that other densities (outside of the given ranges) may be used.

The layout or pattern of the depressions 56 may also or alternatively be characterized in terms of the average pitch, or the spacing from the center of one depression 56 to the center of an adjacent depression 56 (center-to-center spacing) or from the right edge of one depression 56 to the left edge of an adjacent depression 56 (edge-to-edge spacing). The pattern can be regular, such that the coefficient of variation around the average pitch is small, or the pattern can be non-regular in which case the coefficient of variation can be relatively large. In either case, the average pitch can be, for example, about 50 nm, about 0.15 μm, about 0.5 μm, about 1 μm, about 5 μm, about 10 μm, about 100 μm, or more or less. The average pitch for a particular pattern of can be between one of the lower values and one of the upper values selected from the ranges above. In an example, the depressions 56 have a pitch (center-to-center spacing) of about 1.5 μm. While example average pitch values have been provided, it is to be understood that other average pitch values may be used.

The size of each depression 56 may be characterized by its volume, opening area, depth, and/or diameter or length and width. For example, the volume can range from about 1×10⁻³ μm³ to about 100 μm³, e.g., about 1×10⁻² μm³, about 0.1 μm³, about 1 μm³, about 10 μm³, or more, or less. For another example, the opening area can range from about 1×10−3 μm² to about 100 μm², e.g., about 1×10⁻² μm², about 0.1 μm², about 1 μm², at least about 10 μm², or more, or less. For still another example, the depth can range from about 0.1 μm to about 100 μm, e.g., about 0.5 μm, about 1 μm, about 10 μm, or more, or less. For another example, the depth can range from about 0.1 μm to about 100 μm, e.g., about 0.5 μm, about 1 μm, about 10 μm, or more, or less. For yet another example, the diameter or each of the length and the width can range from about 0.1 μm to about 100 μm, e.g., about 0.5 μm, about 1 μm, about 10 μm, or more, or less.

Each of the optical alignment targets 10D, 10E includes an example of the optical target 60 in each of the depressions 56. The optical target 60 is selected from the group consisting of: i) a cured translucent or transparent matrix having a first light emitting material 16′ suspended therein; or ii) a sticky layer having a second light emitting material 16″ attached thereto or at least partially embedded therein.

The cured translucent or transparent matrix having the light emitting material 16′ suspended therein be any of the examples set forth herein for the cured fluorescent material 34. In this particular example, the light emitting material may also include fluorescing glass particles. As particular examples, when the optical target 60 is i) from the list of optical targets 60, the patterned and translucent or transparent material is transparent to an excitation wavelength and an emission wavelength of the first light emitting material (e.g., poly(lactic-co-glycolic acid) or poly(N-(5-azidoacetamidylpentyl) acrylamide-co-acrylamide)), and/or the first light emitting material 16′ is selected from the group consisting of organic dyes, quantum dots, cerium powder, fluorescing glass particles, and fluorescing crystal particles. Examples of fluorescing glass particles include indium fluoride mixed with praseodymium, holmium, or combinations thereof; and examples of fluorescing crystal particles include cerium doped lutetium aluminum garnet (Ce:LuAG).

When the optical target 60 is ii) from the list of optical targets 60, the sticky layer is a polymeric hydrogel; and the second light emitting material 16″ (see FIG. 8) is selected from the group consisting of organic dyes, quantum dots, functionalized quantum dots, cerium powder, fluorescing glass particles, and fluorescing crystal particles. A specific example of the polymeric hydrogel is an acrylamide copolymer. Some examples of the acrylamide copolymer are represented by the following structure (I):

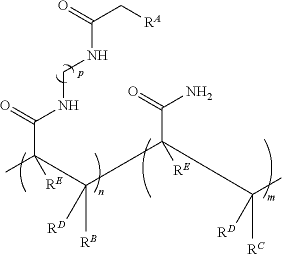

wherein:
R^{A} is selected from the group consisting of azido, optionally substituted amino, optionally substituted alkenyl, optionally substituted alkyne, halogen, optionally substituted hydrazone, optionally substituted hydrazine, carboxyl, hydroxy, optionally substituted tetrazole, optionally substituted tetrazine, nitrile oxide, nitrone, sulfate, and thiol;
R^{B} is H or optionally substituted alkyl;
R^{C}, R^{D}, and R^{E} are each independently selected from the group consisting of H and optionally substituted alkyl;
each of the —(CH₂)ₚ— can be optionally substituted;
p is an integer in the range of 1 to 50;
n is an integer in the range of 1 to 50,000; and
m is an integer in the range of 1 to 100,000.

One specific example of the acrylamide copolymer represented by structure (I) is poly(N-(5-azidoacetamidylpentyl) acrylamide-co-acrylamide, PAZAM.

One of ordinary skill in the art will recognize that the arrangement of the recurring “n” and “m” features in structure (I) are representative, and the monomeric subunits may be present in any order in the polymer structure (e.g., random, block, patterned, or a combination thereof).

The molecular weight of the acrylamide copolymer may range from about 5 kDa to about 1500 kDa or from about 10 kDa to about 1000 kDa, or may be, in a specific example, about 312 kDa.

In some examples, the acrylamide copolymer is a linear polymer. In some other examples, the acrylamide copolymer is a lightly cross-linked polymer.

In other examples, the gel material may be a variation of structure (I). In one example, the acrylamide unit may be replaced with N,N-dimethylacrylamide

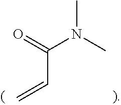

In this example, the acrylamide unit in structure (I) may be replaced with,

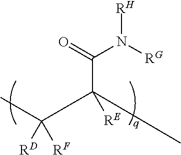

where R^{D}, R^{E}, and R^{F} are each H or a C₁-C₆ alkyl, and R^{G} and R^{H} are each a C₁-C₆ alkyl (instead of H as is the case with the acrylamide). In this example, q may be an integer in the range of 1 to 100,000. In another example, the N,N-dimethylacrylamide may be used in addition to the acrylamide unit. In this example, structure (I) may include

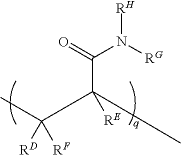

in addition to the recurring “n” and “m” features, where R^{D}, R^{E}, and R^{F} are each H or a C₁-C₆ alkyl, and R^{G} and R^{H} are each a C₁-C₆ alkyl. In this example, q may be an integer in the range of 1 to 100,000.

As another example of the polymeric hydrogel, the recurring “n” feature in structure (I) may be replaced with a monomer including a heterocyclic azido group having structure (II):

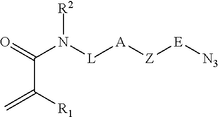

wherein R¹ is H or a C₁-C₆ alkyl; R² is H or a C₁-C₆ alkyl; L is a linker including a linear chain with 2 to 20 atoms selected from the group consisting of carbon, oxygen, and nitrogen and 10 optional substituents on the carbon and any nitrogen atoms in the chain; E is a linear chain including 1 to 4 atoms selected from the group consisting of carbon, oxygen and nitrogen, and optional substituents on the carbon and any nitrogen atoms in the chain; A is an N substituted amide with an H or a C₁-C₄ alkyl attached to the N; and Z is a nitrogen containing heterocycle. Examples of Z include 5 to 10 carbon-containing ring members present as a single cyclic structure or a fused structure. Some specific examples of Z include pyrrolidinyl, pyridinyl, or pyrimidinyl. As still another example, the gel material may include a recurring unit of each of structure (III) and (IV):

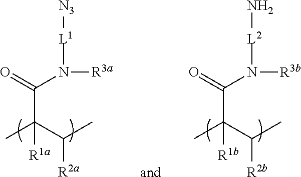

wherein each of R^{1a}, R^{2a}, R^{1b} and R^{2b} is independently selected from hydrogen, an optionally substituted alkyl or optionally substituted phenyl; each of R^{3a} and R^{3b} is independently selected from hydrogen, an optionally substituted alkyl, an optionally substituted phenyl, or an optionally substituted C7-C14 aralkyl; and each L¹ and L² is independently selected from an optionally substituted alkylene linker or an optionally substituted heteroalkylene linker.

In still another example, the acrylamide copolymer is formed using nitroxide mediated polymerization, and thus at least some of the copolymer chains have an alkoxyamine end group. In the copolymer chain, the term “alkoxyamine end group” refers to the dormant species —ONR₁R₂, where each of R₁ and R₂ may be the same or different, and may independently be a linear or branched alkyl, or a ring structure, and where the oxygen atom is attached to the rest of the copolymer chain. In some examples, the alkoxyamine may also be introduced into some of the recurring acrylamide monomers, e.g., at position R^{A} in structure (I). As such, in one example, structure (I) includes an alkoxyamine end group; and in another example, structure (I) includes an alkoxyamine end group and alkoxyamine groups in at least some of the side chains.

Examples of the optical alignment targets 10D, 10E may also have a cured translucent or transparent layer 52 (FIG. 8 at F) in contact with the optical target 60. The cured translucent or transparent layer 52 may be any of the UV light or thermally curable materials described herein. The curable material used to form the layer 52 may be exposed to a baking step as described herein to drive off excess solvent. This layer 52 may be used to protect the surface of the optical alignment targets 10D, 10E, and may be particularly desirable when fluorescing particles are included in the optical target 60. It is to be understood that the layer 52 can overlie the optical target 60 and the interstitial regions 58. Additionally, if used in the examples shown in FIG. 9A through FIG. 9C, the cured translucent or transparent layer 52 could fill the entire fluidic lane/channel 14.

Methods for making the optical alignment target 10D, 10E are shown, respectively, in the FIG. 7 series and FIG. 8. The methods generally include selecting an optical target material 60′ from: i) a translucent or transparent matrix having a first light emitting material 16′ suspended therein; or ii) a sticky material and a second light emitting material 16″; and forming the optical target 60 in depressions 56 of a multi-layered structure using the optical target material 60′, whereby interstitial regions 58 separating the depressions 56 remain free of the optical target 60.

A specific example of the method for making the optical alignment target 10D is shown in FIG. 7A through FIG. 7C.

To generate the structure shown in FIG. 7A, a translucent or transparent material is applied, patterned, and/or cured to form the patterned translucent or transparent material 54.

Some example materials (e.g., inorganic oxides) can be selectively applied via aerosol printing, inkjet printing, screen printing, or microcontact printing, and the depressions 56 can be formed during this process.

Other example materials, e.g., the polymeric resins, may be applied and then patterned to form the depressions 56. For example, the polymeric resins may be deposited using a suitable technique, such as chemical vapor deposition, dip coating, dunk coating, spin coating, spray coating, puddle dispensing, ultrasonic spray coating, doctor blade coating, etc. Suitable patterning techniques include photolithography, nanoimprint lithography (NIL), stamping techniques, embossing techniques, molding techniques, microetching techniques, etc. If a UV or thermally curable resin is used, curing may take place during patterning (e.g., when photolithography, nanoimprint lithography, stamping, or molding techniques are used) or before patterning (e.g., embossing or microetching techniques are used).

The optical target material 60′ is then applied (FIG. 7B) and the optical target 60 is formed therefrom (FIG. 7C).

In one example, the optical target material 60′ is the translucent or transparent matrix having the light emitting material 16′ suspended therein; and forming the optical target 60 involves: applying the optical target material 60′ to the multi-layered structure such that the optical target material 60′ fills the depressions 56 and overlies the interstitial regions 58 (FIG. 7B); solidifying a curable matrix of the optical target material 60′; and removing the solidified optical target material from the interstitial regions 58, thereby leaving the optical target 60 in the depressions 56 (FIG. 7C).

In one example, the optical target material 60′ may be in the form of a slurry, which includes the light emitting material 16′ dispersed throughout the curable matrix. In another example, the optical target material 60′ may be in the form of a dispersion, which includes the quantum dots as the light emitting material 16′, the stabilization additive, and the curable matrix dissolved or dispersed in the solvent blend. Applying the optical target material 60′ may be performed using any suitable deposition technique, such as by spin coating, spraying, dip coating, or the like.

Solidification of the optical target material 60′ may be performed with UV light, heat, or air drying. The technique used will depend upon the material used for the curable matrix. When the solvent blend is used in combination with a light or heat curable material, the baking step described herein may be performed in order to initiate evaporation of the solvent blend prior to solidification.

The solidified optical target material can then be removed from the interstitial regions 58 using chemical mechanical polishing or timed dry etching. Either of these processes can be performed until the interstitial regions 58 are exposed. When timed dry etching is used, the etchant used will depend upon the solidified optical target material that is used. Example etchants for timed dry etching include a reactive ion etch (e.g., with 10% CF₄ and 90% O₂) or a 100% O₂ plasma etch.

The solidified optical target material may also be selected to be softer than the patterned translucent or transparent material 54 so that removal of the solidified optical target material from the interstitial regions 58 does not deleteriously affect the interstitial regions 58. This difference in material hardness enables one to readily determine when the interstitial regions 58 are exposed, and thus when to stop the removal process. This prevents an undesired amount of the solidified optical target material (i.e., optical target 60) from being removed from the depressions 56.

Several examples of the method for making the optical alignment target 10E are shown in FIG. 8. One example method involves A, B, and E, with or without F. Another example method involves A, C, D, and E, with or without F. Each of these methods may be used when the optical target material 60′ is the sticky material 62′. At the outset, each of the methods shown in FIG. 8 includes the patterned transparent and translucent layer 54 positioned over the substrate 18 (not shown for clarity). The patterned transparent and translucent layer 54 may be generated as described in reference to FIG. 7A.

The method that includes A, B, and E, with or without F, will now be described. To generate the structure shown in FIG. 8 at B, a solution containing the sticky material 62′ and the light emitting material 16″ is applied to the patterned transparent and translucent layer 54. In one example, the light emitting material 16″ is dissolved in a solution of sticky material 62′; the solution is applied to the patterned transparent and translucent layer 54 such that it fills the depressions 56 and overlies the interstitial regions 58; the solution is solidified to form the sticky layer 62 having the light emitting material 16″ embedded at least partially therein; and then the sticky layer 62 is removed from the interstitial regions 56.

The solution containing the sticky material 62′ and the light emitting material 16″ may include water or a mixture of water and ethanol.

The solution containing the sticky material 62′ and the light emitting material 16″ may be processed in the same manner as the optical target material 60′. With this example, the removal process may be performed longer in order to remove the sticky layer 62 from the interstitial regions 58 and from a portion of the depressions 56. In one example, the remaining sticky material 62 having the light emitting material 16″ at least partially embedded therein aligns each depression 56.

The optical alignment target 10E may be used as is or may have the cured translucent or transparent layer 52 applied thereto. When the cured translucent or transparent layer 52 is included, it can be formed from a UV or thermally curable material that is transparent to an excitation wavelength and an emission wavelength of the light emitting material 16″. Example materials include a non-fluorescing resin, epoxy, adhesive, or other polymer. Such material is deposited using any of the example deposition methods disclosed herein and then is exposed to UV light or heat for curing.

Another example method involves A, C, D, and E, with or without F. In FIG. 8 at C, the sticky material 62′ is applied to the patterned transparent and translucent layer 54. The sticky material 62′ may be incorporated into a solution with water or a mixture of water and ethanol, but this solution does not include the light emitting material 16″. The solution is applied to the patterned transparent and translucent layer 54 such that it fills the depressions 56 and overlies the interstitial regions 58 and the solution is solidified to form the sticky layer 62. Any suitable deposition and curing technique may be used.

This example method then includes exposing the sticky layer 62 to a suspension 64 containing the light emitting material 16″, whereby the second light emitting material 16″ covalently attaches to, or becomes embedded at least at the surface of the sticky layer 62 (FIG. 8, at D and E); and removing the sticky layer 62 from the interstitial regions 58 before or after the exposure to the suspension 64.

The suspension 64 in this example may be water with the light emitting material 16″ dispersed therein.

In one example, the sticky layer 62 is removed from the interstitial regions 58, and then the suspension 64 is exposed to the sticky layer 62 that remains in the depressions 56. In another example, the suspension 64 is exposed to the sticky layer 62 that is on the interstitial regions 58 and in the depressions 56, and then the sticky layer 62 (with the light emitting material 16″ embedded at least partially therein) is removed from the interstitial regions 58. In either instance, sticky layer 62 removal from the interstitial regions 58 may be performed as described herein. For example, polishing may be performed until the interstitial regions 58 are exposed.

In either example, suspension exposure takes place for a time sufficient to allow the light emitting material 16″ to covalently attach or at least become partially embedded at the surface of the sticky layer 62. In one example, the suspension exposure times ranges from about 1 minute to about 10 minutes. It is believed that longer exposure times may also be used. After a suitable incubation time, the suspension 64 may be washed away. After being washed, the sticky layer 62 may be further dried, which shrinks the layer 62 and further embeds the light emitting material 16″.

Again, the optical alignment target 10E may be used as is or may have the cured translucent or transparent layer 52 applied thereto.

In any of the examples shown in FIG. 8, it is to be understood that the light emitting material 16″ may be covalently attached to the sticky layer 62 in addition to being at least partially embedded. For example, then the light emitting material 16″ is a functionalized quantum dot, the surface groups covalently attach to functional groups (e.g., R^{A} in structure (I)).

In any of the examples utilizing the sticky layer 62, it is to be understood that the sticky layer 62 can be stabilized with a chemical process. In one example, the sticky layer 62 is PAZAM, and the chemical process involves exposing the PAZAM to hexynoic acid, which crosslinks the hydrogel by reacting with unreacted azide sites.

The optical alignment targets 10D, 10E (with or without the layer 52) may be incorporated into a device that resembles the corresponding analytical apparatus (FIG. 9A), or into a mechanical housing 40 that is part of an optical instrument or can be introduced into an optical instrument (FIG. 9B), or first incorporated into a device that resembles the corresponding analytical apparatus and then into a mechanical housing 40 (FIG. 9C).

Referring now to FIG. 9A, two optical alignment targets 10D, 10E and 10D′, 10E′ are attached to one another, e.g., via the interposer 42, and the channel 14 is formed therebetween. Thus, the example shown in FIG. 9A includes a first structure (i.e., optical alignment target 10D, 10E), which includes the patterned and translucent or transparent material 54 over the substrate 18 having the port(s) 30, 30′ defined therein, and the optical target 60 in each of the depressions 56; a second structure 10D′, 10E′ attached to the first structure 10D or 10E, where the second structure 10D′, 10E′ includes a second patterned and translucent or transparent material 54′ over a second substrate 28, and a second optical target 60″ in each of the depressions of the second patterned and translucent or transparent material 54′; and the sealable channel 14 formed therebetween. In this example, the optical targets 60, 60″ are the same.

The optical alignment targets 10D, 10D′ or 10E, 10E′ may be formed using the methods described in reference to the FIG. 7 series or to FIG. 8, respectively. In this example, the substrate 18 has the port(s) 30, 30′ defined therein and the substrate 28 does not have port(s) 30, 30′ defined therein.

In the example shown in FIG. 9A, the interposer 42 is used to attach the optical alignment targets 10D, 10D′ or 10E, 10E′ together. The interposer 42 is attached to each of the optical alignment targets 10D, 10D′ or 10E, 10E′ at respective bonding regions 32 (e.g., where optical targets 60, 60″ are not formed). In this example, the interposer 42 defines the walls of the channel 14. The interposer 42 may be any of the examples set forth herein, and may be attached to the bonding regions 32 as described herein.

The port(s) 30, 30′ may be sealed as described herein in reference to FIG. 2. Prior to sealing the port(s) 30, 30′, the channel 14 may be filled with a liquid, a curable translucent or transparent material, or a gas, and then sealed. Examples of suitable liquids are selected from the group consisting of water, salt water, ethylene glycol, and mineral oil. Examples of suitable curable translucent or transparent materials include any of the materials set forth herein for the layer 52. Examples of suitable gases include air or nitrogen. In one example, an exit port 30′ may be sealed, the liquid or gas may be introduced into the channel 14 via an inlet port 30, and then the exit port 30′ may be sealed to enclose the liquid or gas within the channel 14. In another example, the curable translucent or transparent material may be introduced into the channel 14 and into the port(s) 30, 30′, and then the curable translucent or transparent material may be cured. This forms a solid in the channel 14 and in the port(s) 30, 30′, and thus seals may not be used.

In another example similar to that shown in FIG. 9A, the substrate 18 does not include port(s) 30, 30′. In this example, the channel 14 is formed when the interposer 42 is secured and is filled with air.

In another example, as shown in FIG. 9B, the optical alignment target 10D or 10E is incorporated into a mechanical housing 40. This mechanical housing 40 may be a permanent component of an optical instrument or a removable component that can be introduced into an optical instrument.

The mechanical housing 40 includes an inset region 45 (i.e., a receptacle) that that leads to a pocket 44. The inset region 45 functions as a receptacle for the optical alignment target 10D or 10E. In one example, the optical alignment target 10D or 10E can be positioned within the inset region 45 so that the perimeter of the optical alignment target 10D or 10E contacts the surfaces of the inset region 45. In this position, the optical targets 60 in the depressions 56 face the pocket 44 of the mechanical housing 40. The optical alignment target 10D or 10E may be secured within the inset region 45 in various manners, such as with an adhesive. The inset region 45 may also be formed with peripheral features that securely engage with peripheral walls of the optical alignment target 10D or 10E (e.g., in a press fit manner). When secured to the mechanical housing 40, the optical targets 60 may be hermetically sealed from the external environment.

Prior to introducing the optical alignment target 10D or 10E into the mechanical housing 40, the pocket 44 may be filled with the liquid or curable translucent or transparent material.

In FIG. 9C, the optical alignment targets 10D, 10D′ or 10E, 10E′ may be attached as described in reference to FIG. 9A and then this device may be introduced into the mechanical housing 40 as described in reference to FIG. 9B (except that the substrate 28 will contact the inset region/receptacle 45).

In both FIG. 9A and FIG. 9C, two substrates 18, 28 with respective patterns of optical targets 60, 60″ are included in the optical alignment tool 12. The dual surface configuration of the optical targets 60, 60″ mimics the inner surfaces of patterned flow cell substrates that include patterned depressions, which are functionalized with surface chemistry where analytes with fluorescent labels are sequenced. As depicted, excitation light 66 can be focused to the optical targets 50 in the depressions 56 of the optical alignment target 10D or 10E and of the optical alignment target 10D′ or 10E′. Thus, the optical targets 60, 60″ can be configured specifically for the type of analytical device being used. This enables image quality, focus, and other alignment and validation information to be obtained for both surfaces of the corresponding analytical device.

### Optical Alignment Target Patterns

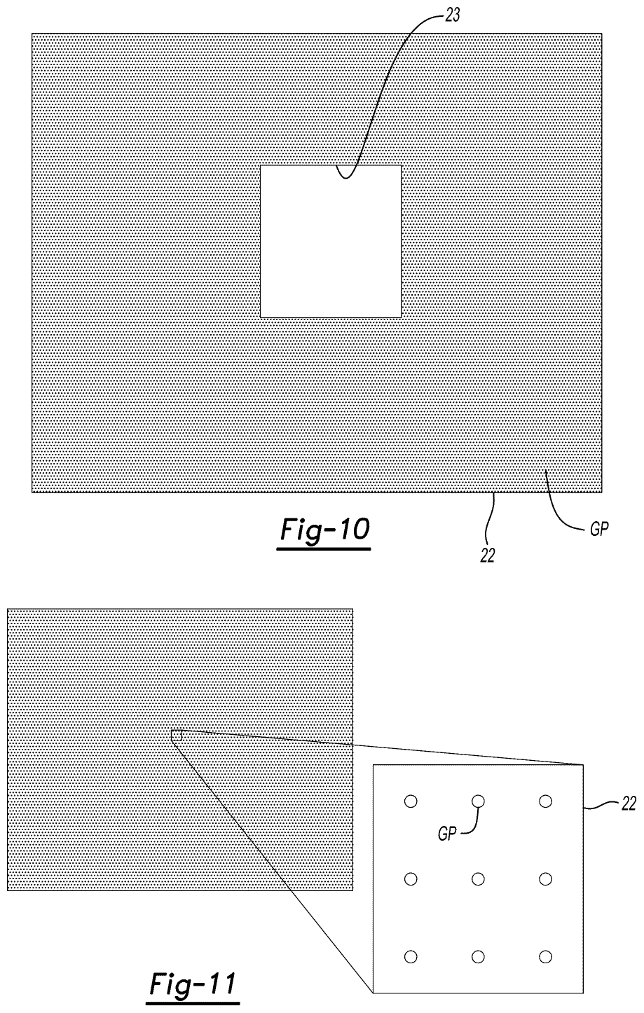

The opaque material 22 or the depressions 56 that contain the optical target 60 may have any suitable pattern. The pattern may form a tile that is used for testing autofocus, image quality, camera XY offset, or other calibration, alignment, or measurement parameters. Two example patterns are shown in FIG. 10 and FIG. 11.

FIG. 10 depicts an example of a pattern for an autofocus tile. The pattern includes the opaque material 22 with 5 μm holes (gap portions GP, represented by the darker dots) spaced apart from one another by about 15 μm. This pattern can be used to determine best focus. The middle of the pattern includes a relatively large opening 23 in the opaque material 22. The opening 23 allows the autofocus laser of each microfluorometer in an imaging module to pass through and generate lane/channel top and lane bottom reflections. The shape and sharpness of the resulting images are used to determine focus.

FIG. 11 depicts an example of a pattern for an image quality tile. A relatively large field of view is depicted, with a higher magnification portion at the right. The pattern includes the opaque material 22 with circular holes (gap portions GP) having diameters of 1 μm, 0.5 μm, or 0.3 μm spaced apart from one another by about 2 μm to about 3 μm. In some examples, the tolerance in hole size variation is +/−30 nm or +/−50 nm, which allows for a desired level of accuracy in calibration measurements. The resulting square grid of objects is useful for image quality measurements, optical alignment measurements (theta-XYZ), and distortion measurements, e.g., revealing barrel or pincushion distortion in an imaging system. The holes produce spots in the image that produce about 3300 counts on the imaging system whereas the background (interstitial) areas produce 400 counts.

Other patterns may be used for testing distortion, for creating fiducials, or the like.

### Use of the Optical Alignment Targets

The optical alignment target 10 (e.g., 10A, 10B, etc.) disclosed herein may be used for alignment (e.g., optical alignment in any of the six degrees of freedom) and validation (e.g. calibration, quantification, or characterization of optical properties) of imaging modules used in, for example, optical detection of samples, such as those samples detected in nucleic acid sequencing procedures. The optical alignment targets 10 and methods set forth herein are particularly useful, for example, in alignment and validation for imaging modules set forth in U.S. patent application Ser. No. 13/766,413 filed on Feb. 13, 2013, published as U.S. Patent Pub. No. 2013/0260372 A1, and entitled “INTEGRATED OPTOELECTRONIC READ HEAD AND FLUIDIC CARTRIDGE USEFUL FOR NUCLEIC ACID SEQUENCING,” the content of which is incorporated by reference in its entirety.

In an example, the imaging module may be part of a fully-integrated nucleic acid sequencer system. Examples of such sequencing systems include HISEQ™ HISEQX™, MISEQ™, MISEQDX™, MINISEQ™, NEXTSEQ™, NEXTSEQDX™, NOVASEQ™, ISEQ™, GENOME ANALYER™, and other instrument platforms offered by Illumina Inc. (San Diego, Calif.) and/or instruments offered by other companies.

The optical alignment targets 10 disclosed herein may also be used in other fluidic or non-fluid optical instruments. As examples, the optical alignment targets 10 may be utilized in connection with micro-fluidics, semiconductors, biotechnology, and consumer industry instruments. For example, the optical alignment targets 10 may be utilized for alignment of a semiconductor tool, such as mask aligners and steppers; for calibration of a machine vision system; for optical stages in applications such as optical coherence tomography; for calibration of standard consumer optical tools, such as fluorescence microscopes; and for alignment and/or calibration of other fluorescence-based biological imaging systems in addition to the sequencing instruments mentioned herein.

In one example, the optical alignment target 10 may be utilized as a built-in diagnostic optical target. In this example, the optical alignment target 10 may be permanently mounted within the optical instrument and positioned to enable a detector within the instrument to perform optical measurements without having to manually load any additional tool. The optical alignment target 10 may be used, by the instrument, to provide remote diagnostic information in connection with various activities. For example, the instrument may utilize the optical alignment target 10 to perform data trending, such as trends in a point spread function of an instrument, laser alignment, optical calibration, and optical transmission efficiency over the life of the instrument. Data can be collected automatically with no user intervention and uploaded to the cloud in order to perform remote debugging, perform predictive diagnostics, and examine trends across multiple instruments. The optical alignment target 10 may be utilized to evaluate various aspects of the instrument's optical system, as well as aspects of its XYZ stage(s). For example, if the laser alignments are found to be off, software can automatically actuate the pointing mirrors to bring the laser into alignment.

In another example, the optical alignment target 10 may be loaded into and removed from the instrument that performs optical measurements and analysis. As such, any of the example optical alignment targets 10 described herein may be shaped and dimensioned to be mounted within the instrument. In one specific example, the optical alignment target 10 is a full-sized inspection apparatus that will mate with a flow cell holder of a sequencing system and that will be utilized to evaluate flow cell holder alignment. The full-size optical alignment target 10 will extend the full length of a sequencing flow cell to enable a simulation of a sequencing run. Alternatively, the optical alignment target 10 may be reduced in size and mounted within the instrument at a staging location, adjacent to the flow cell lanes.

In accordance with some examples, the optical alignment target 10 may be assembled and shipped with each instrument, where the instrument includes a current software release of the optical alignment target 10 that controls the instrument to carry out various tests with the optical alignment target 10.

As specific examples, the optical alignment target 10 can be used (1) in any optical instrument, (2) at any point in the manufacture process of the optical instrument (e.g., sequencer) after the imaging module is installed, (3) as a field service tool for installation or service of an optical instrument, (4) in quality control fixtures for evaluating manufacture of various components of the instrument, or (5) in a stand-alone camera module test station.

When used, the optical alignment target 10 can be illuminated with a light source that is part of the instrument, such as a green and/or red LED in the camera modules (e.g., microfluorometers). In this example, the LED illumination will excite the light emitting material 16, 16′, 16″ and/or optical target 60 in the optical alignment target 10. It is also possible to use a light source that is extrinsic to the instrument, such as a backlight that is positioned to shine up through the optical alignment target 10 when the optical alignment target 10 is located in the instrument. Two examples of the illumination are shown in FIG. 12 and FIG. 13.

An example inspection method can use a back illumination of the optical alignment target 10 (which is part of an optical alignment tool 12) as diagrammed in FIG. 12. In this example, the optical alignment tool 12 is placed on the flow cell holder of a sequencer, e.g., a NEXTSEQ® imaging module, and an external backlight illuminates the underside of the optical alignment tool 12. White light from a lamp can be used. The light passes through the lower substrate 28, through the channel 14, and to the lower surface 20 of the upper substrate 18. At this surface 20, the light will either be blocked by the opaque portions OP or it will transmit through the gap portions GP and the substrate 18 to the camera module of the instrument that is under analysis. The opaque portions OP appear as dark shadows in a field of light detected by the camera. The optical components can be focused on the opaque portions OP and accuracy of focus can be determined from the sharpness of the shadows produced by the opaque portions OP.

An alternative inspection method is diagrammed in FIG. 13 where an LED of the sequencer is used instead of an external backlight. In this case, the channel 14 of the optical alignment target 10 (which is part of an optical alignment tool 12) is filled with a fluid suspension 26 that is excited by the LED to produce a fluorescent emission. As shown by the diagram of FIG. 13, the optical alignment target 10 can be placed for epifluorescence detection such that excitation light impinges on the top side of the substrate 18 and transmits to the lower surface 20. LED light can pass into the channel 14 to excite the light emitting material 16, but LED light that hits the opaque material 22/opaque portions OP is prevented from exciting the light emitting material 16. Emission from the light emitting material 16 passes back through the upper substrate 18 and to the camera, where it is detected. Again, the resulting image will appear as a pattern of shadows cast by the opaque material 22 in a field of fluorescent emission light. The optical components can be focused on the opaque material 22 and focus can be determined from the sharpness of the shadows produced by the opaque material 22.

### Optical Instrument/System

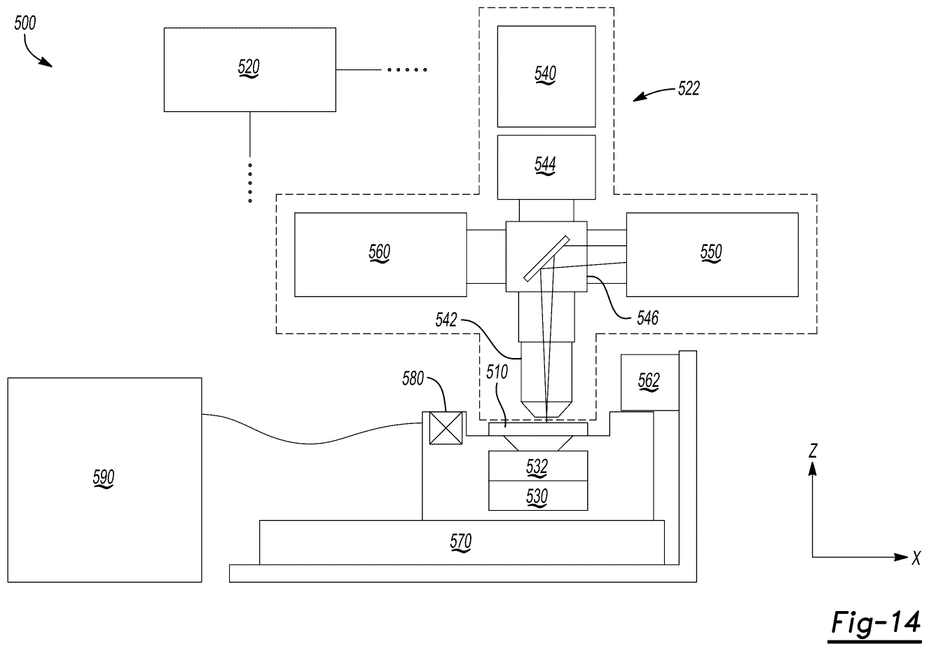

FIG. 14 illustrates a schematic diagram of an optical instrument/system 500 that may be used to perform an analysis on one or more samples of interest, and that can be aligned and validated with the optical alignment targets set forth herein. System 500 is configured to perform a large number of parallel reactions within a flow cell 510. In an example, the flow cell 510 may include one or more flow channels that receive a solution from system 500 and direct the solution toward reaction sites of flow cell 510.

System 500 includes a system controller 520 that may communicate with the various components, assemblies, and sub-systems of the system 500.

A controller 520 includes a user interface, a communication interface, one or more processors, and a memory storing instructions executable by the one or more processors to perform various functions. User interface, communication interface, and memory are electrically and/or communicatively coupled to the one or more processors. User interface may be adapted to receive input from a user and to provide information to the user associated with the operation of system 500 and/or an analysis taking place. User interface may include a touch screen, a display, a keyboard, a speaker(s), a mouse, a track ball, and/or a voice recognition system.

An imaging assembly 522 of system 500 includes a light emitting assembly 550 that emits light that reaches reaction sites on flow cell 510. Light emitting assembly 550 may include an incoherent light emitter (e.g., emit light beams output by one or more excitation diodes), or a coherent light emitter such as emitter of light output by one or more lasers or laser diodes. In some implementations, light emitting assembly 550 may include a plurality of different light sources (not shown), each light source emitting light of a different wavelength range. Some versions of light emitting assembly 550 may also include one or more collimating lenses (not shown), a light structuring optical assembly (not shown), a projection lens (not shown) that is operable to adjust a structured beam shape and path, epifluorescence microscopy components, and/or other components. Although system 500 is illustrated as having a single light emitting assembly 550, multiple light emitting assemblies 550 may be included in some other implementations.

In the present example, the light from light emitting assembly 550 is directed by dichroic mirror assembly 546 through an objective lens assembly 542 onto a sample of a flow cell 510, which is positioned on a motion stage 570. In the case of fluorescent microscopy of a sample, a fluorescent element associated with the sample of interest fluoresces in response to the excitation light, and the resultant light is collected by objective lens assembly 542 and is directed to an image sensor of camera system 540 to detect the emitted fluorescence. In some implementations, a tube lens assembly may be positioned between the objective lens assembly 542 and the dichroic mirror assembly 546 or between the dichroic mirror 546 and the image sensor of the camera system 540. A moveable lens element may be translatable along a longitudinal axis of the tube lens assembly to account for focusing on an upper interior surface or lower interior surface of the flow cell 510 and/or spherical aberration introduced by movement of the objective lens assembly 542.

In the present example, a filter switching assembly 544 is interposed between dichroic mirror assembly 546 and camera system 540. Filter switching assembly 544 includes one or more emission filters that may be used to pass through particular ranges of emission wavelengths and block (or reflect) other ranges of emission wavelengths. For example, emission filters may be used to direct different wavelength ranges of emitted light to different image sensors of the camera system 540 of imaging assembly 522. For instance, the emission filters may be implemented as dichroic mirrors that direct emission light of different wavelengths from flow cell 510 to different image sensors of camera system 540. In some variations, a projection lens is interposed between filter switching assembly 544 and camera system 540. Filter switching assembly 544 may be omitted in some versions.

System 500 further includes a fluid delivery assembly 590 that may direct the flow of reagents (e.g., fluorescently labeled nucleotides, buffers, enzymes, cleavage reagents, etc.) to (and through) flow cell 510 and waste valve 580. The fluid delivery assembly 590 can include first and second manifold fluidic lines that attach to the inlet and outlet ports of the flow cell 510.

The fluid delivery assembly 590 may include a sample cartridge receptacle and interface that receive and establish fluid connection with a sample cartridge. A sample loading manifold assembly and pump manifold assembly flow one or more samples of interest from the sample cartridge through a fluidic line toward the flow cell 510. In an example, the sample cartridge and sample loading manifold assembly are positioned downstream of flow cell 510, and the sample loading manifold assembly is coupled between flow cell 510 and pump manifold assembly. To draw a sample of interest from the sample cartridge and toward pump manifold assembly, sample valves, pump valves, and/or pumps may be selectively actuated to urge the sample of interest toward pump manifold assembly. Sample cartridge may include a plurality of sample reservoirs that are selectively fluidically accessible via the corresponding sample valves. To individually flow the sample of interest toward channel of flow cell 510 and away from pump manifold assembly, sample valves, pump valves, and/or pumps may be selectively actuated to urge the sample of interest toward flow cell 520 and into respective channels thereof.

Sample loading manifold assembly includes one or more sample valves. Pump manifold assembly includes one or more pumps, one or more pump valves, and a cache to temporarily store one or more reaction components during, for example, bypass manipulations of the system 500.

A drive assembly interfaces with a sipper manifold assembly and the pump manifold assembly to flow one or more reagents that interact with the sample within flow cell 510.

A primary waste fluidic line is coupled between pump manifold assembly and waste reservoir. In some implementations, pumps and/or pump valves of pump manifold assembly selectively flow the reaction components from the flow cell 510, through the fluidic line and the sample loading manifold assembly to the primary waste fluidic line.

The sipper manifold assembly includes a shared line valve (i.e., reagent selector valve) and a bypass valve. A central valve and the valves of the sipper manifold assembly may be selectively actuated to control the flow of fluid through the fluidic lines. The sipper manifold assembly may be coupled to a corresponding number of reagent reservoirs via reagent sippers. Reagent reservoirs may contain fluid (e.g., reagent and/or another reaction component). In some implementations, sipper manifold assembly includes a plurality of ports. Each port of sipper manifold assembly may receive one of the reagent sippers. Some forms of reagent sippers may include an array of sipper tubes extending downwardly along the z-dimension from ports in the body of sipper manifold assembly. Reagent reservoirs may be provided in a cartridge, and the tubes of reagent sippers may be configured to be inserted into corresponding reagent reservoirs in the reagent cartridge so that liquid reagent may be drawn from each reagent reservoir into the sipper manifold assembly.

The shared line valve of the sipper manifold assembly is coupled to the central valve via shared reagent fluidic line. Different reagents may flow through the shared reagent fluidic line at different times.

The bypass valve of the sipper manifold assembly is coupled to the central valve via dedicated reagent fluidic lines. Each of the dedicated reagent fluidic lines may be associated with a single reagent. The fluids that may flow through dedicated reagent fluidic lines may be used during sequencing operations and may include a cleave reagent, an incorporation reagent, a scan reagent, a cleave wash, and/or a wash buffer.

The bypass valve is also coupled to the cache of the pump manifold assembly via the bypass fluidic line. One or more reagent priming operations, hydration operations, mixing operations, and/or transfer operations may be performed using bypass fluidic line. The priming operations, the hydration operations, the mixing operations, and/or the transfer operations may be performed independent of flow cell 510. Thus, the operations using bypass fluidic line may occur during, for example, incubation of one or more samples of interest within flow cell 510.

The drive assembly includes a pump drive assembly and a valve drive assembly. Pump drive assembly may be adapted to interface with one or more pumps to pump fluid through flow cell 510 and/or to load one or more samples of interest into flow cell 510. Valve drive assembly may be adapted to interface with one or more of the valves to control the position of the corresponding valves.

The system 500 may also include a temperature station actuator 530 and heater/cooler 532 that may optionally regulate the temperature of conditions of the fluids within the flow cell 510. In some implementations, the heater/cooler 532 may be fixed to sample stage 570, upon which the flow cell 510 is placed, and/or may be integrated into sample stage 570.

Flow cell 510 may be removably mounted on sample stage 570, which may provide movement and alignment of flow cell 510 relative to objective lens assembly 542. Sample stage 570 may have one or more actuators to allow sample stage 570 to move in any of three dimensions. For example, actuators may be provided to allow sample stage 570 to move in the X, Y, and Z directions relative to objective lens assembly 542, tilt relative to objective lens assembly 542, and/or otherwise move relative to objective lens assembly 542. Movement of sample stage 570 may allow one or more sample locations on flow cell 510 to be positioned in optical alignment with objective lens assembly 542. Movement of sample stage 570 relative to objective lens assembly 542 may be achieved by moving sample stage 570 itself, by moving objective lens assembly 542, by moving some other component of imaging assembly 522, by moving some other component of system 500, or any combination of the foregoing. For instance, in some implementations, the sample stage 570 may be actuatable in the x and y directions relative to the objective lens assembly 542 while a focus component 562 or z-stage may move the objective lens assembly 542 along the z direction relative to the sample stage 570.

In some implementations, a focus component 562 may be included to control positioning of one or more elements of objective lens assembly 542 relative to the flow cell 510 in the focus direction (e.g., along the z-axis or z-dimension). Focus component 562 may include one or more actuators physically coupled to the objective lens assembly 542, the optical stage, the sample stage 570, or a combination thereof, to move flow cell 510 on sample stage 570 relative to the objective lens assembly 542 to provide proper focusing for the imaging operation. In the present example, the focus component 562 utilizes a focus tracking module 560 that is configured to detect a displacement of the objective lens assembly 542 relative to a portion of the flow cell 510 and output data indicative of an in-focus position to the focus component 562 or a component thereof or operable to control the focus component 562, such as controller 520, to move the objective lens assembly 542 to position the corresponding portion of the flow cell 510 in focus of the objective lens assembly 542.

In some implementations, an actuator of focus component 562 or of sample stage 570 may be physically coupled to objective lens assembly 542, the optical stage, sample stage 570, or a combination thereof, such as, for example, by mechanical, magnetic, fluidic, or other attachment or contact directly or indirectly to or with the stage or a component thereof. The actuator of focus component 562 may be configured to move objective lens assembly 542 in the z-direction while maintaining sample stage 570 in the same plane (e.g., maintaining a level or horizontal attitude, perpendicular to the optical axis). In some implementations, sample stage 570 includes an x direction actuator and a y direction actuator to form an x-y stage. Sample stage 570 may also be configured to include one or more tip or tilt actuators to tip or tilt sample stage 570 and/or a portion thereof, to account for any slope in its surfaces.

A camera system 540 may include one or more image sensors to monitor and track the imaging (e.g., sequencing) of flow cell 510. The camera system 540 may be implemented, for example, as a CCD or CMOS image sensor camera, but other image sensor technologies (e.g., active pixel sensor) may be used. By way of further example only, camera system 540 may include a dual-sensor time delay integration (TDI) camera, a single-sensor camera, a camera with one or more two-dimensional image sensors, and/or other kinds of camera technologies. While camera system 540 and associated optical components are shown as being positioned above flow cell 510 in FIG. 14, one or more image sensors or other camera components may be incorporated into system 500 in numerous other ways as will be apparent to those skilled in the art in view of the teachings herein. For instance, one or more image sensors may be positioned under flow cell 510, such as within the sample stage 570 or below the sample stage 570; or may even be integrated into flow cell 510.

### NON-LIMITING WORKING EXAMPLES

To further illustrate the present disclosure, examples are given herein. It is to be understood that these examples are provided for illustrative purposes and is not to be construed as limiting the scope of the present disclosure.

### Example 1

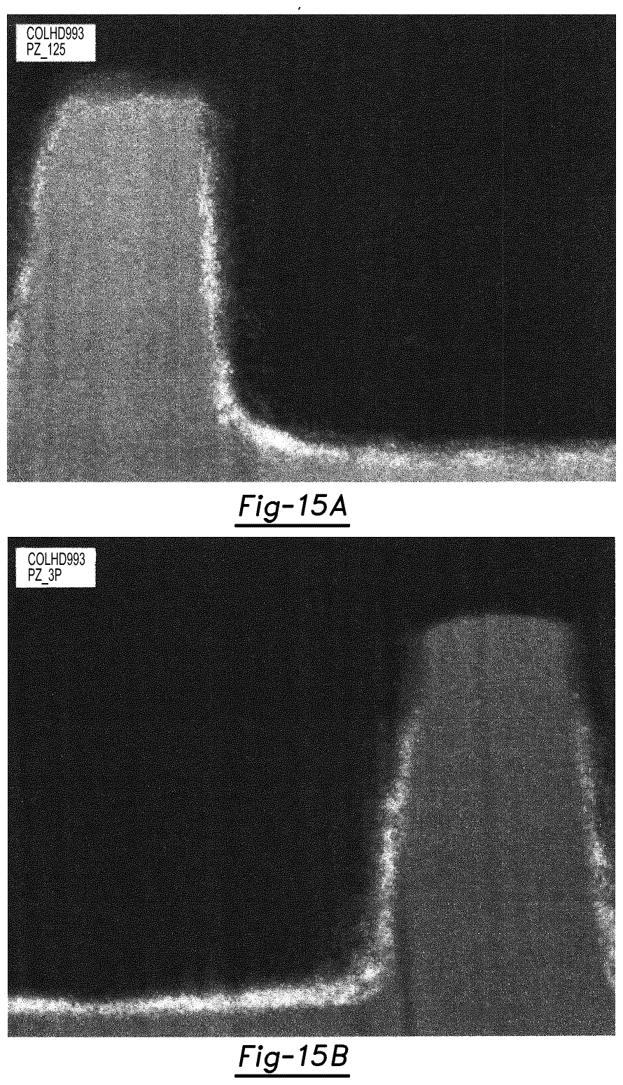

A nanoimprint lithography (NIL) resin was deposited on a glass substrate and imprinting with a working stamp to form depressions having a diameter of about 250 nm and a depth of about 250 nm. PAZAM was coated on the patterned NIL resin and cured. A suspension of 1 nm alkyne-terminated gold nanoparticles was prepared in water, and the structure was incubated in the suspension for a time ranging from 1 minute to 10 minutes. A scanning electron micrograph (SEM) image was taken, after incubation, of a portion of one depression and an interstitial region. This image is shown in FIG. 15A. The bright white portion lining the interstitial region and the depression is indicative of the functionalized nanoparticles attached to the PAZAM.

Chemical mechanical polishing was performed to remove the PAZAM and the attached nanoparticles from the interstitial regions. Another SEM was taken, after polishing, of another portion of one depression and an interstitial region. This image is shown in FIG. 15B. The interstitial region is free of the bright white portion, indicating that polishing effectively removed the PAZAM and the attached functionalized nanoparticles from that region, while leaving the PAZAM and the attached functionalized nanoparticles intact in the depression.

### Example 2

Two example formulations (Ex. 8 and Ex. 9) containing a solvent blend (i.e., PGMEA and Toluene) and a stabilization additive (i.e., poly(ethylene glycol) were prepared. Eight comparative formulations (Comp. 1-Comp. 7) were also prepared. Some of the comparative formulations did not include the solvent blend (Comp. 1, 2, 3, 4) or included a solvent blend with an undesirable weight ratio (Comp. 5 and 8) of the two solvents. Some of the comparative formulations did not include the stabilization additive (Comp. 1, 2, 5, 6, 7). The formulations are shown in Table 1.

TABLE 1

| | | | Stabilization |
|---|---|---|---|
| | Quantum | Solvent(s) | Additive |
| Sample | Dots | (weight ratio) | (wt %) |
| Comp. 1 | cadmium | Toluene | None |
| | selenide | | |
| Comp. 2 | cadmium | PGMEA | None |
| | selenide | | |
| Comp. 3 | cadmium | PGMEA | 1 wt % PEG |
| | selenide | | |
| Comp. 4 | cadmium | PGMEA | 5 wt % PEG |
| | selenide | | |
| Comp. 5 | cadmium | PGMEA:Toluene | None |
| | selenide | (90:10) | |
| Comp. 6 | cadmium | PGMEA:Toluene | None |
| | selenide | (75:25) | |
| Comp. 7 | cadmium | PGMEA:Toluene | None |
| | selenide | (50:50) | |
| Comp. 8 | cadmium | PGMEA:Toluene | 5 wt % PEG |
| | selenide | (90:10) | |
| Ex. 9 | cadmium | PGMEA:Toluene | 5 wt % PEG |
| | selenide | (75:25) | |
| Ex. 10 | cadmium | PGMEA:Toluene | 5 wt % PEG |
| | selenide | (50:50) | |

All of formulations were tested to determine the suspension stability of the quantum dots in the formulations. The absorbance of each formulation, as a function of wavelength, was measured using a spectrophotometer. The formulation was then passed through a 0.45 μm PTFE filter to remove any aggregates or poorly suspended quantum dots and another measurement was taken using the spectrophotometer. The percentage retention of absorbance at 400 nm before and after filtration was used to determine the extent to which the quantum dots were filtered out from solution, with a larger change indicating a less stable suspension. This wavelength was used because it showed a strong signal for the quantum dot species used, which had a high absorption at that wavelength. The percentage of retained absorbance was calculated by (Filtered absorbance/Unfiltered Absorbance)*100. Table 2 illustrate the percentage of retained absorbance after filtration. A higher percentage of retained absorbance indicates a more stable suspension, where greater than 75% is suitable.

TABLE 2

| | Percent Retained Absorbance |
|---|---|
| Sample | (Filtered/Unfiltered)*100 |
| Comp. 1 | 70.9 |
| Comp. 2 | 11.7 |
| Comp. 3 | 10.0 |
| Comp. 4 | 13.1 |
| Comp. 5 | 7.6 |
| Comp. 6 | 21.5 |
| Comp. 7 | 92.0 |
| Comp. 8 | 21.3 |
| Ex. 9 | 78.5 |
| Ex. 10 | 101.5 |

As illustrated by these results, the addition of poly(ethylene glycol) (PEG) in formulations containing the PGMEA:Toluene blend at a ratio ranging from 40:60 to 75:25 improved the stability of the quantum dot suspension. This is highlighted in the comparison of Comp. 7 and Ex. 10, which included the same weight ratio of the solvents, but Comp. 7 had no stabilization additive and Ex. 10 included the stabilization additive.

### Additional Notes

In any of the examples disclosed herein using the UV curable material, it is to be understood that the UV dose used to cure the material will depend upon the composition of the material, the intensity of the light source, the duration of UV light exposure, whether the UV light is directed through another material, e.g., substrate 18, and the distance from the light source to the UV curable material.

FIG. 2, FIG. 5A through FIG. 5C, FIG. 6A, FIG. 6B, FIG. 8, and FIG. 9A through FIG. 9C each depict a single optical alignment target 10. It is to be understood that each of these optical alignment targets 10 may be replicated in a single optical alignment tool 12, as shown in FIG. 1, any desirable number of times. As one example, the tool 12 may include multiple optical alignment targets 10A (FIG. 2). In this example, the tool 12 includes one of each of the substrates 18, 28, and several isolated fluid channels 14 defined between the substrates 18, 28. The light emitting material 16 and the fluid suspension 26 are located within each of the channels, as described in reference to FIG. 2.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

While several examples have been described in detail, it is to be understood that the disclosed examples may be modified. Therefore, the foregoing description is to be considered non-limiting.

1. An optical alignment target, comprising:
a translucent or transparent substrate having a bottom surface;
an opaque material formed over the bottom surface in a pattern, the pattern having an opaque portion of an opaque material and having a gap portion devoid of the opaque material;
an enclosed channel disposed below the bottom surface;
a fluid suspension contained in the enclosed channel, the fluid suspension including a carrier liquid and a light emitting material suspended in the carrier liquid, the light emitting material being selected from the group consisting of quantum dots and cerium powder; and
a second substrate secured to the translucent or transparent substrate such that the enclosed channel is defined between the two substrates.

2. The optical alignment target as defined in claim 1, wherein:
the carrier liquid is selected from the group consisting of water, ethanol, and ethylene glycol; and
a concentration of the light emitting material in the carrier liquid ranges from about 0.1% to about 5% in terms of number density.

3. The optical alignment target as defined in claim 1, wherein the light emitting material is the cerium powder, and wherein the cerium powder includes particles having an average particle size of from about 1 nm to less than 100 nm.

4. (canceled)

5. (canceled)

6. The optical alignment target as defined in claim 1, wherein the fluid suspension further includes a stabilization additive.

7. An optical alignment target, comprising:
a translucent or transparent substrate having a bottom surface;
an opaque material formed over the bottom surface in a pattern, the pattern having an opaque portion of an opaque material and having a gap portion devoid of the opaque material;
an enclosed channel disposed below the bottom surface; and
a cured fluorescent material filling at least the gap portions of the pattern.

8. The optical alignment target as defined in claim 7, wherein the cured fluorescent material fills the gap portions and fills the enclosed channel, and wherein the cured fluorescent material is selected from the group consisting of an ultraviolet light cured material and a heat cured material.

9. The optical alignment target as defined in claim 8, wherein the cured fluorescent material is the UV light cured material, and the ultraviolet light cured material includes:
a matrix that is i) transparent to an excitation wavelength and an emission wavelength of a light emitting material dispersed therein, and ii) selected from the group consisting of a cured liquid photopolymer and a cured epoxy; and
the light emitting material dispersed in the matrix, the light emitting material being selected from the group consisting of organic dyes, quantum dots, and cerium powder.

10. (canceled)

11. The optical alignment target as defined in claim 7, wherein:
the cured fluorescent material fills the gap portions;
the cured fluorescent material is an ultraviolet light cured thin film having a thickness ranging from about 0.1 μm to about 10 μm; and
the ultraviolet light cured thin film includes:
a matrix that is transparent to an excitation wavelength and an emission wavelength of a light emitting material dispersed therein; and
the light emitting material selected from the group consisting of organic dyes, quantum dots, and cerium powder having an average particle size of about 100 nm.

12. (canceled)

13. (canceled)

14. The optical alignment target as defined in claim 11, further comprising:
a second translucent or transparent substrate attached to the first translucent or transparent substrate such that the enclosed channel is formed therebetween;
a second ultraviolet light cured thin film positioned over the second translucent or transparent substrate and in the channel, the second ultraviolet light cured thin film having a thickness ranging from about 0.1 μm to about 10 μm; and
an interposer attached to each of the first translucent or transparent substrate and the second translucent or transparent substrate at respective bonding regions.

15. (canceled)

16. The optical alignment target as defined in claim 7, further comprising:
a second translucent or transparent substrate attached to the first translucent or transparent substrate such that the enclosed channel is formed therebetween; and
spacer objects of a predetermined size positioned within the cured fluorescent material and defining at least a portion of a distance between the first translucent or transparent substrate and the second translucent or transparent substrate, wherein the the spacer objects are selected from the group consisting of glass particles, polystyrene particles, and silicon dioxide particles, and the predetermined size is a diameter ranging from about 0.1 μm to about 10 μm.

17. (canceled)

18. (canceled)

19. The optical alignment target as defined in claim 16, wherein the cured fluorescent material fills the gap portions and fills the enclosed channel.

20. The optical alignment target as defined in claim 16, further comprising:
a glass spacer in contact with the cured fluorescent material;
a second cured fluorescent material positioned between the glass spacer and the second translucent or transparent substrate; and
second spacer objects of a second predetermined size that defines at least an other portion of the distance between the first translucent or transparent substrate and the second translucent or transparent substrate.

21. (canceled)

22. The optical alignment target as defined in claim 20, wherein each of the cured fluorescent material and the second cured fluorescent material is a respective ultraviolet light cured thin film having a thickness ranging from about 0.1 μm to about 10 μm, and wherein each of the respective ultraviolet light cured thin films includes:
a matrix that is transparent to an excitation wavelength and an emission wavelength of a light emitting material dispersed therein; and
the light emitting material selected from the group consisting of organic dyes, quantum dots, and cerium powder.

23. The optical alignment target as defined in claim 7, wherein the cured fluorescent material further includes a stabilization additive.

24. An optical alignment target, comprising:
a substrate;
a patterned and translucent or transparent material over the substrate, the patterned translucent or transparent material including depressions separated by interstitial regions; and
an optical target in each of the depressions, the optical target including:
i) a cured translucent or transparent matrix having a first light emitting material suspended therein; or
ii) a sticky layer having a second light emitting material attached thereto or at least partially embedded therein.

25. The optical alignment target as defined in claim 24, wherein:
the optical target is i);
the first light emitting material is selected from the group consisting of organic dyes, quantum dots, cerium powder, fluorescing glass particles, and fluorescing crystal particles; and
the patterned and translucent or transparent material is transparent to an excitation wavelength and an emission wavelength of the first light emitting material.

26. (canceled)

27. The optical alignment target as defined in claim 25, wherein the translucent or transparent matrix is selected from the group consisting of poly(lactic-co-glycolic acid) and poly(N-(5-azidoacetamidylpentyl) acrylamide-co-acrylamide).

28. The optical alignment target as defined in claim 24, further comprising a mechanical housing having a pocket defined therein and a receptacle to position the optical target in fluid communication with the pocket, wherein the substrate is positioned in the receptacle.

29. The optical alignment target as defined in claim 28, further comprising one of:
a liquid in the sealable channel, wherein the liquid is selected from the group consisting of water, salt water, ethylene glycol, and mineral oil; or
a cured translucent or transparent material in the sealable channel; or
a gas in the sealable channel, where the gas is air or nitrogen.

30. (canceled)

31. (canceled)

32. The optical alignment target as defined in claim 24, wherein:
the optical target is ii);
the sticky layer is a polymeric hydrogel; and
the second light emitting material is selected from the group consisting of organic dyes, quantum dots, functionalized quantum dots, cerium powder, fluorescing glass particles, and fluorescing crystal particles.

33. (canceled)

34. The optical alignment target as defined in claim 32, wherein the second light emitting material is partially embedded at a surface of the polymeric hydrogel.

35. The optical alignment target as defined in claim 32, further comprising a cured translucent or transparent layer in contact with the optical target.

36. An optical alignment target, comprising:
a first structure, including:
a substrate;
a patterned and translucent or transparent material over the substrate, the patterned translucent or transparent material including depressions separated by interstitial regions; and
an optical target in each of the depressions, the optical target including:
i) a cured translucent or transparent matrix having a first light emitting material suspended therein; or
ii) a sticky layer having a second light emitting material attached thereto or at least partially embedded therein;
a second structure attached to the first structure, the second structure including:
a second substrate;
a second patterned and translucent or transparent material positioned on the second substrate, the second patterned and translucent or transparent material including second depressions separated by second interstitial regions; and
a second optical target in each of the second depressions, wherein the second optical target is the same as the optical target; and
a sealable channel defined between the optical target the second optical target.

37. The optical alignment target as defined in claim 36, further comprising one of:
a liquid in the sealable channel, wherein the liquid is selected from the group consisting of water, salt water, ethylene glycol, and mineral oil; or
a cured translucent or transparent material in the sealable channel; or
a gas in the sealable channel, where the gas is air or nitrogen.

38. (canceled)

39. (canceled)

40. The optical alignment target as defined in claim 36, further comprising a mechanical housing having a receptacle for the attached first and second structures, wherein the attached first and second structures are positioned in the receptacle.

41.-47. (canceled)
